(19) United States
(12) Patent Application Publication
(10) Pub. No.: US 2021/0328258 A1
(43) Pub. Date: Oct. 21, 2021

(54) Method For Producing Solid Composition And Method For Producing Functional Ceramic Molded Body

(71) Applicant: Seiko Epson Corporation, Tokyo (JP)

(72) Inventors: Masahiro FURUSAWA, Chino (JP); Tomofumi YOKOYAMA, Matsumoto (JP); Naoyuki TOYODA, Suwa (JP); Hitoshi YAMAMOTO, Chino (JP); Tsutomu TERAOKA, Matsumoto (JP)

(21) Appl. No.: 17/229,905

(22) Filed: Apr. 14, 2021

(30) Foreign Application Priority Data
Apr. 15, 2020 (JP) 2020-072730

(51) Int. Cl. H01M 10/0562; B28B 11/24; H01M 10/0525

(52) U.S. Cl. CPC H01M 10/0562; H01M 2300/0074; H01M 10/0525; B28B 11/24

(57) ABSTRACT

A method for producing a solid composition according to the present disclosure includes producing an oxide to be converted into a first functional ceramic by reacting with an oxoacid compound, and mixing the oxide, the oxoacid compound, and a second functional ceramic that is different from the first functional ceramic. The oxoacid compound preferably contains at least one of a nitrate ion and a sulfate ion as an oxoanion.

The present application is based on, and claims priority from JP Application Serial Number 2020-072730, filed on Apr. 15, 2020, the disclosure of which is hereby incorporated by reference herein in its entirety.

### BACKGROUND

### 1. Technical Field

The present disclosure relates to a method for producing a solid composition and a method for producing a functional ceramic molded body.

### 2. Related Art

Various types of functional ceramics constituted by a composite oxide, specifically, for example, functional ceramics such as a solid electrolyte to be used in an all-solid-state battery such as a lithium-ion battery, a phosphor ceramic, a wavelength conversion ceramic, a magnetic ceramic, and a superconductor ceramic are known.

Heretofore, a composite oxide ceramic has been obtained by mixing a plurality of oxide particles or compounds composed of each of the constituent elements thereof and performing a synthetic reaction in an oxidizing atmosphere, followed by grinding and molding, and thereafter, performing high temperature firing again.

For example, Japanese Patent No. 5763683 (Patent Document 1) discloses a method in which when a composite body including yttrium aluminum garnet that is a phosphor ceramic and a wavelength conversion ceramic in a stacked manner is produced, a mixture of oxide powders to serve as the raw materials of both the phosphor ceramic and the wavelength conversion ceramic is subjected to tape molding, and the molded materials are stacked, followed by high temperature firing.

Further, JP-A-2011-73937 (Patent Document 2) describes a method for forming a magnetic ceramic for a nonreciprocal circuit element by integrally firing an yttrium iron garnet ceramic to be used as a ferrite core with an electric conductor composed of a noble metal.

Further, JP-A-2017-94442 (Patent Document 3) discloses that in order to form a YBCO element to be used as a superconductor, YBCO synthesized by high temperature firing is ground to obtain a ground material, and thereafter, the ground material is hardened by firing again, whereby a bulky element is obtained.

In the case of the above Patent Document 1, by performing a heat treatment, that is, firing again after grinding a product obtained by a heat treatment, that is, annealing, yttrium ions are volatilized in the firing gas, and therefore, there was a problem that the formulation of a ceramic to be finally obtained deviates from a desired formulation, and a desired property cannot be obtained.

Further, in the above Patent Document 2, by simultaneously firing different oxides at a high temperature, unnecessary elemental diffusion is likely to occur at a heterogeneous interface, and a defect such as an oxygen vacancy is generated inside, and therefore, there was a problem that the properties as the phosphor are deteriorated.

Further, in the above Patent Document 3, an impurity crystal involved in the phase transition of a crystal or the generation of an oxygen defect is likely to be formed during refiring at a high temperature, and there was a problem that a critical current density in a magnetic field that is a main property as a superconductor is decreased.

In order to avoid such a problem, a firing aid is sometimes added, however, in that case, the addition is sometimes accompanied by reaction firing, and a byproduct such as water or an acid is generated when releasing heat accompanying thermal decomposition of a flux or phase transformation, and therefore, there was a problem that an interface between heterogeneous materials is etched.

### SUMMARY

The present disclosure has been made for solving the above problems and can be realized as the following application examples.

A method for producing a solid composition according to an application example of the present disclosure includes: producing an oxide to be converted into a first functional ceramic by reacting with an oxoacid compound; and mixing the oxide, the oxoacid compound, and a second functional ceramic that is different from the first functional ceramic.

Further, a method for producing a functional ceramic molded body according to an application example of the present disclosure includes: a molding step of obtaining a molded body using a solid composition obtained using the method for producing a solid composition according to the present disclosure; and a heat treatment step of subjecting the molded body to a heat treatment so as to react the oxide and the oxoacid compound in the solid composition to cause conversion to the first functional ceramic, thereby forming a functional ceramic molded body containing the first functional ceramic and the second functional ceramic.

### BRIEF DESCRIPTION OF THE DRAWINGS

FIG. 1 is a cross-sectional view schematically showing a solid composition according to the present disclosure.

FIG. 2 is a schematic perspective view schematically showing a configuration of a lithium-ion secondary battery of a first embodiment.

FIG. 3 is a schematic perspective view schematically showing a configuration of a lithium-ion secondary battery of a second embodiment.

FIG. 4 is a schematic cross-sectional view schematically showing a structure of the lithium-ion secondary battery of the second embodiment.

FIG. 5 is a schematic perspective view schematically showing a configuration of a lithium-ion secondary battery of a third embodiment.

FIG. 6 is a schematic cross-sectional view schematically showing a structure of the lithium-ion secondary battery of the third embodiment.

FIG. 7 is a schematic perspective view schematically showing a configuration of a lithium-ion secondary battery of a fourth embodiment.

FIG. 8 is a schematic cross-sectional view schematically showing a structure of the lithium-ion secondary battery of the fourth embodiment.

FIG. 9 is a flowchart showing a method for producing the lithium-ion secondary battery of the first embodiment.

FIG. 10 is a schematic view schematically showing the method for producing the lithium-ion secondary battery of the first embodiment.

FIG. 11 is a schematic view schematically showing the method for producing the lithium-ion secondary battery of the first embodiment.

FIG. 12 is a schematic cross-sectional view schematically showing another method for forming a solid electrolyte layer.

FIG. 13 is a flowchart showing a method for producing the lithium-ion secondary battery of the second embodiment.

FIG. 14 is a schematic view schematically showing the method for producing the lithium-ion secondary battery of the second embodiment.

FIG. 15 is a schematic view schematically showing the method for producing the lithium-ion secondary battery of the second embodiment.

FIG. 16 is a flowchart showing a method for producing the lithium-ion secondary battery of the third embodiment.

FIG. 17 is a schematic view schematically showing the method for producing the lithium-ion secondary battery of the third embodiment.

FIG. 18 is a schematic view schematically showing the method for producing the lithium-ion secondary battery of the third embodiment.

FIG. 19 is a flowchart showing a method for producing the lithium-ion secondary battery of the fourth embodiment.

FIG. 20 is a schematic view schematically showing the method for producing the lithium-ion secondary battery of the fourth embodiment.

### DESCRIPTION OF EXEMPLARY EMBODIMENTS

Hereinafter, preferred embodiments of the present disclosure will be described in detail.

### [1] Solid Composition

First, prior to a method for producing a solid composition according to the present disclosure, a solid composition according to the present disclosure, that is, a solid composition produced using the method for producing a solid composition according to the present disclosure will be described.

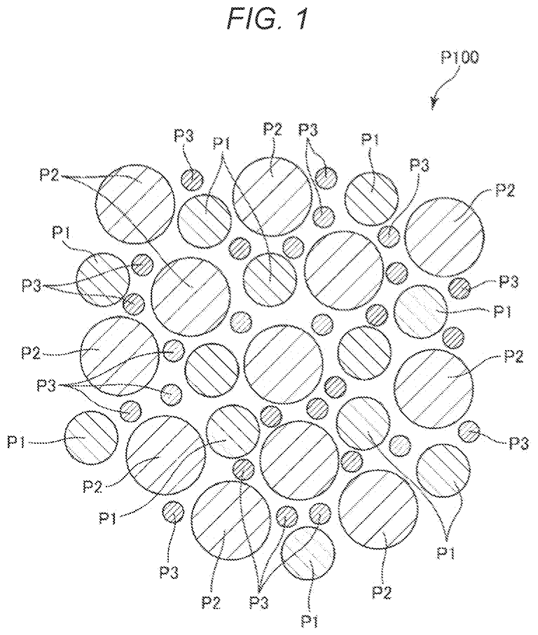

FIG. 1 is a cross-sectional view schematically showing the solid composition according to the present disclosure.

The solid composition according to the present disclosure is one produced using the method for producing a solid composition according to the present disclosure, which will be described in detail later.

Such a solid composition contains an oxide to be converted into a first functional ceramic by reacting with an oxoacid compound. Further, the solid composition contains a second functional ceramic that is different from the first functional ceramic and the oxoacid compound together with the oxide. That is, the solid composition according to the present disclosure contains at least the oxide, the oxoacid compound, and the second functional ceramic.

According to such a configuration, a solid composition that can be favorably used for producing a functional ceramic molded body having a high denseness and high reliability can be provided. More specifically, by containing an oxoacid compound, the melting point of the oxide contained in the solid composition can be lowered, and the oxide that is a constituent material of the solid composition can be converted into a first functional ceramic while promoting the crystal growth, and also the adhesion between the first functional ceramic and the second functional ceramic, or the like can be made excellent by a firing treatment that is a heat treatment at a relatively low temperature for a relatively short time. As a result, the functional ceramic molded body to be formed has a high denseness, achieves effective prevention of undesirable formulation change or crystal phase transition, or the like, and has high reliability. Further, while suppressing interface etching or generation of byproducts, the melting point of the oxide can be lowered, and the firing temperature or the joining temperature with a heterogeneous material can be lowered, and for example, the adhesion to an adherend can be made excellent even by a heat treatment at a relatively low temperature.

On the other hand, when the conditions as described are not satisfied, satisfactory results are not obtained.

For example, when the solid composition is constituted only by particles composed of the second functional ceramic, when the composition is fired, a void is likely to remain between the particles, and a functional ceramic molded body having a sufficiently high denseness cannot be obtained. As a result, the functional ceramic molded body to be obtained has a low denseness and poor reliability. In particular, when firing of the composition is performed at a relatively low temperature as described later, such a problem more prominently occurs.

Further, even if the solid composition contains the oxoacid compound together with the oxide, when the solid composition does not contain the second functional ceramic, it becomes difficult to sufficiently increase the denseness when the solid composition is fired.

Further, even if the solid composition contains the oxide together with the second functional ceramic, when the solid composition does not contain the oxoacid compound, the effect of lowering the melting point of the oxide cannot be obtained, and when the solid composition is fired, a void is likely to remain between particles, and a functional ceramic molded body having a sufficiently high denseness cannot be obtained. In particular, when firing of the composition is performed at a relatively low temperature as described later, such a problem more prominently occurs.

Further, even if the solid composition contains the oxoacid compound together with the second functional ceramic, when the solid composition does not contain the oxide, the first functional ceramic cannot be formed. As a result, in a functional ceramic molded body to be finally obtained, an impurity derived from the oxoacid compound which is neither the first functional ceramic nor the second functional ceramic is contained, and the property and reliability of the functional ceramic molded body are deteriorated.

As described above, the oxide is converted into the first functional ceramic by reacting with the oxoacid compound. In other words, it can be said that the oxide is a precursor of the first functional ceramic. Therefore, in the following description, the oxide is also referred to as “precursor oxide”.

In the present disclosure, the functional ceramic refers to a ceramic refers to a ceramic having some sort of function such as an optical function, a magnetic function, an electrical function, a chemical function, an electrochemical function, a mechanical function, or a thermodynamic function.

A solid composition P100 shown in FIG. 1 contains first particles P1 constituted by the precursor oxide, the second particles P2 constituted by the second functional ceramic, and third particles P3 constituted by the oxoacid compound. In other words, the precursor oxide, the second functional ceramic, and the oxoacid compound each constitute different particles.

According to such a configuration, the reaction of the precursor oxide with the oxoacid compound can be allowed to more efficiently proceed when producing the functional ceramic molded body which will be described in detail later. Further, the adhesion of the first functional ceramic formed by the reaction of the precursor oxide with the oxoacid compound to the second functional ceramic, and the adhesion of the particles of the second functional ceramic, and the like can be made more excellent in the functional ceramic molded body to be obtained. Accordingly, the denseness, durability, reliability, and the like of the functional ceramic molded body can be made more excellent. Further, the productivity of the functional ceramic molded body can be further enhanced.

### [1-1] Precursor Oxide

The precursor oxide is a substance to be converted into the first functional ceramic by reacting with the oxoacid compound.

The precursor oxide may have a crystal phase different from that of the first functional ceramic at normal temperature and normal pressure.

Note that in this specification, “normal temperature and normal pressure” refers to 25° C. and 1 atm. Further, in this specification, the “different” in terms of crystal phase is a broad concept not only including that the type of crystal phase is not the same, but also including that even if the type is the same, at least one lattice constant is different, or the like.

There are various combinations of the form of the crystal phase of the precursor oxide with the form of the crystal phase of the first functional ceramic, however, for example, when the crystal phase of the precursor oxide is a pyrochlore-type crystal, the crystal phase of the first functional ceramic is a cubic garnet-type crystal.

According to this, even if the heat treatment for the solid composition P100 is performed at a lower temperature for a shorter time, a solid electrolyte molded body as the functional ceramic molded body having a particularly excellent ion conduction property can be favorably obtained.

Further, when the crystal phase of the precursor oxide is a pyrochlore-type crystal, when the second functional ceramic is a cubic garnet-type crystal, the adhesion between the first functional ceramic formed from the precursor oxide and the second particles P2 constituted by the second functional ceramic can be made more excellent. As a result, the denseness of the functional ceramic molded body can be further increased, and the reliability, durability, and the like of the functional ceramic molded body can be made more excellent. In particular, when the functional ceramic molded body to be formed in this manner is a solid electrolyte molded body, the grain boundary resistance of the solid electrolyte molded body can be further decreased, and the ion conductivity and denseness thereof can be further increased.

By heating the solid composition P100 containing the precursor oxide of a pyrochlore-type crystal at a relatively low temperature, for example, in a temperature range of 700° C. or higher and 1000° C. or lower, particularly in a temperature range of 800° C. or higher and 950° C. or lower, a high quality functional ceramic molded body constituted by a cubic garnet-type crystal can be obtained.

Further, for example, when the crystal phase of the precursor oxide is a perovskite-type crystal, the crystal phase of the first functional ceramic is a cubic garnet-type crystal.

The garnet-type crystal had a problem that the formulation is likely to deviate due to volatilization of the A-site ion during high temperature firing, and elemental segregation occurs at a grain boundary triple point or the like, and therefore, the properties of a ceramic are likely to deteriorate. On the other hand, according to the present disclosure, due to the lowering of the temperature at which crystal phase transformation occurs or the lowering of the melting point by the oxoacid, the uniformity of the formulation and the crystallinity are improved, and therefore, a process of performing formation and firing of a crystal at a low temperature can be applied, and in particular, when the crystal phase of the precursor oxide is a perovskite-type crystal, the first functional ceramic constituted by a cubic garnet-type crystal can be more stably formed with a desired formulation. Accordingly, when the crystal phase of the precursor oxide is a perovskite-type crystal and the crystal phase of the first functional ceramic is a cubic garnet-type crystal, the effect of the present disclosure is more remarkably exhibited.

Further, when the crystal phase of the precursor oxide is a perovskite-type crystal, when the second functional ceramic has a cubic garnet-type crystal, the adhesion between the first functional ceramic to be formed from the precursor oxide and the second particles P2 constituted by the second functional ceramic can be made more excellent. As a result, the denseness of the functional ceramic molded body can be further increased, and the reliability, durability, and the like of the functional ceramic molded body can be made more excellent.

By heating the solid composition P100 containing the precursor oxide of a perovskite-type crystal at a relatively low temperature, for example, in a temperature range of 700° C. or higher and 1000° C. or lower, particularly in a temperature range of 800° C. or higher and 950° C. or lower, a high quality functional ceramic molded body constituted by a cubic garnet-type crystal can be obtained.

Further, for example, when the crystal phase of the precursor oxide is a cubic crystal, the crystal phase of the first functional ceramic is a perovskite-type crystal.

According to this, even if the firing is performed at a lower temperature, the functional ceramic molded body as a fired body having high crystallinity can be favorably obtained.

Further, when the crystal phase of the precursor oxide is a cubic crystal, when the second functional ceramic has a perovskite-type crystal, the adhesion between the first functional ceramic to be formed from the precursor oxide and the second particles P2 constituted by the second functional ceramic can be made more excellent. As a result, the denseness of the functional ceramic molded body can be further increased, and the reliability, durability, and the like of the functional ceramic molded body can be made more excellent.

By heating the solid composition P100 containing the precursor oxide of a cubic crystal at a relatively low temperature, for example, in a temperature range of 700° C. or higher and 1000° C. or lower, particularly in a temperature range of 800° C. or higher and 950° C. or lower, a high quality functional ceramic molded body constituted by a perovskite-type crystal can be obtained.

Further, for example, when the crystal phase of the precursor oxide is a YFeO₃-type crystal, the crystal phase of the first functional ceramic is a garnet-type crystal.

According to this, even if the firing is performed at a lower temperature, the functional ceramic molded body as a fired body having high crystallinity is likely to be favorably obtained, and for example, a thin film having a high magneto-optical property is easily obtained.

Further, when the crystal phase of the precursor oxide is a YFeO₃-type crystal, when the second functional ceramic has a garnet-type crystal, the adhesion between the first functional ceramic to be formed from the precursor oxide and the second particles P2 constituted by the second functional ceramic can be made more excellent. As a result, the denseness of the functional ceramic molded body can be further increased, and the reliability, durability, and the like of the functional ceramic molded body can be made more excellent.

By heating the solid composition P100 containing the precursor oxide of a YFeO₃-type crystal at a relatively low temperature, for example, in a temperature range of 700° C. or higher and 1000° C. or lower, particularly in a temperature range of 720° C. or higher and 800° C. or lower, a high quality functional ceramic molded body constituted by a garnet-type crystal can be obtained.

The crystal phase constituting the precursor oxide and the crystal phase constituting the first functional ceramic are not limited to those described above.

The formulation of the precursor oxide is not particularly limited, and is generally determined according to the formulation of the first functional ceramic to be formed, the type of the functional ceramic molded body, or the like.

For example, when the first functional ceramic to be formed is YAG:Ce³⁺ to be used as a phosphor ceramic or the like, that is, cerium-doped yttrium aluminum garnet, the precursor oxide is preferably a composite oxide containing yttrium, aluminum, and cerium.

Further, when the first functional ceramic to be formed is YBCO to be used as a superconductor ceramic or the like, that is, yttrium barium copper perovskite, the precursor oxide is preferably a composite oxide containing yttrium, barium, and copper.

Further, when the first functional ceramic to be formed is a solid electrolyte, the precursor oxide is preferably a composite oxide containing La, Zr, and M wherein M is at least one type of element selected from the group consisting of Nb, Ta, and Sb.

According to this, even when a heat treatment for the solid composition P100 is performed at a lower temperature for a shorter time, a solid electrolyte molded body having a particularly excellent ion conduction property can be favorably obtained. In addition, for example, in an all-solid-state secondary battery, the adhesion of the solid electrolyte as the first functional ceramic to be formed to a positive electrode active material or a negative electrode active material can be made more excellent, and a composite material can be formed so as to have a more favorable close contact interface, and thus, the properties and reliability of the all-solid-state secondary battery can be made more excellent.

The M need only be at least one type of element selected from the group consisting of Nb, Ta, and Sb, but is preferably two or more types of elements selected from the group consisting of Nb, Ta, and Sb.

According to this, the above-mentioned effect is more remarkably exhibited.

When the precursor oxide is a composite oxide containing La, Zr, and M, it is preferred that the ratio of substance amounts of La, Zr, and M contained in the precursor oxide is 3:2-x:x, and a relationship: 0<x<2.0 is satisfied.

According to this, the above-mentioned effect is more remarkably exhibited.

Further, when the precursor oxide is a composite oxide containing La, Zr, and M, it is preferred that the precursor oxide does not contain Li.

The precursor oxide, particularly, the precursor oxide containing two or more types of metal elements is generally produced through a method of performing a heat treatment.

On the other hand, Li has particularly high volatility among various types of metal elements, and is easily volatilized even in a heating treatment in the process for producing the precursor oxide. Therefore, when the precursor oxide contains Li, it becomes difficult to obtain the precursor oxide having a formulation as designed, and as a result, even in a solid electrolyte molded body that is the functional ceramic molded body to be produced using the solid composition P100, it becomes difficult to obtain a formulation as designed. However, when the precursor oxide does not contain Li, the occurrence of such a problem can be effectively prevented.

Further, when the precursor oxide is a composite oxide containing La, Zr, and M, it is preferred that diffraction angles 2θ in an X-ray diffraction pattern of the precursor oxide are 28.4°, 32.88°, 47.2°, 56.01°, and 58.73°.

When this condition is satisfied, the distribution of the respective constituent elements in the precursor oxide can be made more uniform, and therefore, the problem that a specific element is deposited at a grain boundary during firing when producing the functional ceramic molded body to deteriorate the properties can be more effectively prevented.

The crystal grain diameter of the precursor oxide is not particularly limited, but is preferably 10 nm or more and 200 nm or less, more preferably 15 nm or more and 180 nm or less, and further more preferably 20 nm or more and 160 nm or less.

According to this, due to a so-called Gibbs-Thomson effect that is a phenomenon of lowering the melting point with an increase in surface energy, the melting temperature of the precursor oxide or the firing temperature of the solid composition P100 can be further lowered. Further, this is also advantageous to the improvement of joining of the first functional ceramic to a heterogeneous material or the reduction of the defect density.

The precursor oxide is preferably constituted by a substantially single crystal phase.

According to this, the precursor oxide undergoes crystal phase transition substantially once when producing the functional ceramic molded body using the solid composition P100, that is, when generating a high-temperature crystal phase, and therefore, segregation of elements accompanying the crystal phase transition or generation of a contaminant crystal by thermal decomposition is suppressed, so that various properties of the functional ceramic molded body to be produced, for example, optical, magnetic, electrical, chemical, electrochemical, mechanical, and thermodynamic properties are further improved.

In a case where only one exothermic peak is observed in a range of 300° C. or higher and 1,000° C. or lower when measurement is performed by TG-DTA at a temperature raising rate of 10° C./min for the solid composition according to the present disclosure, it can be determined that “it is constituted by a substantially single crystal phase”.

The content of the precursor oxide in the solid composition P100 is not particularly limited, but is preferably 1.0 mass % or more and 52 mass % or less, more preferably 3.5 mass % or more and 47 mass % or less, and further ore preferably 8.5 mass % or more and 35 mass % or less.

According to this, even when a heat treatment for the solid composition P100 is performed at a lower temperature for a shorter time, the functional ceramic molded body having an excellent desired property can be more stably produced.

The solid composition according to the present disclosure may contain multiple types of precursor oxides. When the solid composition according to the present disclosure contains multiple types of precursor oxides, as the value of the content of the precursor oxide in the solid composition according to the present disclosure, the sum of the contents thereof shall be adopted.

In the solid composition P100 of this embodiment, the precursor oxide is contained in the first particles P1.

For example, multiple types of precursor oxides may be contained in a single first particle P1, or the solid composition P100 may contain different types of precursor oxides to be contained as multiples types of first particles P1.

The average particle diameter of the first particles P1 is preferably 0.01 μm or more and 10 μm or less, more preferably 0.1 μm or more and 5 μm or less, and further more preferably 0.5 μm or more and 3 μm or less.

According to this, the fluidity and ease of handling of the solid composition P100 can be made more favorable. Further, in the functional ceramic molded body to be produced using the solid composition P100, the first functional ceramic and the second functional ceramic can be distributed in a more favorable form, and an undesirable variation in the formulation or the like in the functional ceramic molded body can be suppressed, and the denseness and reliability of the functional ceramic molded body can be made more excellent. Further, this is also advantageous from the viewpoint of improvement of the productivity of the solid composition P100 and reduction of the production cost.

Note that in this specification, the average particle diameter refers to a volume-based average particle diameter, and can be determined by, for example, subjecting a dispersion liquid prepared by adding a sample to methanol and dispersing the sample for 3 minutes using an ultrasonic disperser to measurement with a particle size distribution analyzer according to the Coulter counter method (model TA-II, manufactured by Coulter Electronics, Inc.) using an aperture of 50 μm.

In the drawing, the first particle P1 has a perfect spherical shape, but the shape of the first particle P1 is not limited thereto.

The first particles P1 need only contain the precursor oxide, and may contain another component in addition to the precursor oxide.

However, the content of the precursor oxide in the first particles P1 is more than 50 mass %, and particularly, it is preferably 90.0 mass % or more, more preferably 95.0 mass % or more, and further more preferably 99.5 mass % or more.

The content of the precursor oxide may be different in the plurality of first particles P1 constituting the solid composition P100. In such a case, as the value of the content of the precursor oxide in the first particles P1, the average value of the contents of the precursor oxide in the plurality of first particles P1 constituting the solid composition P100 shall be adopted. In other words, as the value of the content of the precursor oxide in the first particles P1, the ratio of the total mass of the precursor oxide to the mass of the assembly of all the first particles P1 constituting the solid composition P100 shall be adopted.

The solid composition P100 generally includes a plurality of first particles P1, but may include, for example, the first particles P1 having mutually different conditions. For example, the solid composition P100 may include the first particles P1 in which at least one of the particle diameter, shape, and formulation is different.

### [1-2] Oxoacid Compound

The solid composition P100 contains an oxoacid compound.

By containing the oxoacid compound in this manner, the melting point of the precursor oxide is favorably lowered, and the crystal growth of the composite oxide as the first functional ceramic can be promoted, and by a heat treatment at a relatively low temperature for a relatively short time, the first functional ceramic having a desired property can be stably formed. In addition, the adhesion between the first functional ceramic to be formed and an adherend can be made favorable.

The oxoacid compound is a compound containing an oxoanion.

The oxoanion constituting the oxoacid compound does not contain a metal element, and for example, a halogen oxoacid, a borate ion, a carbonate ion, an orthocarbonate ion, a carboxylate ion, a silicate ion, a nitrite ion, a nitrate ion, a phosphite ion, a phosphate ion, an arsenate ion, a sulfite ion, a sulfate ion, a sulfonate ion, a sulfinate ion, and the like are exemplified. As the halogen oxoacid, for example, a hypochlorous ion, a chlorite ion, a chlorate ion, a perchlorate ion, a hypobromite ion, a bromite ion, a bromate ion, a perbromate ion, a hypoiodite ion, an iodite ion, an iodate ion, a periodate ion, and the like are exemplified.

In particular, the oxoacid compound preferably contains, as the oxoanion, at least one of a nitrate ion and a sulfate ion, and more preferably contains a nitrate ion.

According to this, the melting point of the precursor oxide is more favorably lowered, and the crystal growth of the composite oxide as the first functional ceramic can be more effectively promoted. As a result, even when the heat treatment for the solid composition P100 is performed at a lower temperature for a shorter time, the first functional ceramic having an excellent desired property can be favorably obtained.

A cation constituting the oxoacid compound is not particularly limited, and examples thereof include a hydrogen ion, an ammonium ion, a lithium ion, a lanthanum ion, a zirconium ion, a niobium ion, a tantalum ion, antimony ion, an yttrium ion, an aluminum ion, a cerium ion, a barium ion, and a copper ion, and one type or a combination of two or more types selected from these can be used. Above all, the cation constituting the oxoacid compound is preferably an ion of a constituent metal element of the first functional ceramic.

According to this, an undesirable impurity can be more effectively prevented from remaining in the functional ceramic molded body to be formed.

The content of the oxoacid compound in the solid composition P100 is not particularly limited, but is preferably 0.1 mass % or more and 11 mass % or less, more preferably 0.2 mass % or more and 8.0 mass % or less, and furthermore preferably 0.3 mass % or more and 4.3 mass % or less.

According to this, the functional ceramic molded body can be favorably obtained from the solid composition P100 by a heat treatment at a lower temperature for a shorter time while more reliably preventing the oxoacid compound from undesirably remaining in the functional ceramic molded body to be formed using the solid composition P100, and the desired property of the functional ceramic molded body to be obtained can be made particularly excellent.

When the content of the precursor oxide in the solid composition P100 is represented by XP [mass %] and the content of the oxoacid compound in the solid composition P100 is represented by XO [mass %], it is preferred to satisfy a relationship: 0.001≤XO/XP≤4.00, it is more preferred to satisfy a relationship: 0.01≤XO/XP≤2.00, and it is further more preferred to satisfy a relationship: 0.05≤XO/XP≤0.25.

According to this, the functional ceramic molded body can be favorably obtained from the solid composition P100 by a heat treatment at a lower temperature for a shorter time while more reliably preventing the oxoacid compound from undesirably remaining in the functional ceramic molded body to be formed using the solid composition P100, and the desired property of the functional ceramic molded body to be obtained can be made particularly excellent.

The solid composition according to the present disclosure may contain multiple types of oxoacid compounds. When the solid composition according to the present disclosure contains multiple types of oxoacid compounds, as the value of the content of the oxoacid compound in the solid composition according to the present disclosure, the sum of the contents thereof shall be adopted.

In the solid composition P100 of this embodiment, the oxoacid compound is contained in the third particles P3.

For example, multiple types of oxoacid compounds may be contained in a single third particle P3, or the solid composition P100 may contain different types of oxoacid compounds to be contained as multiples types of third particles P3.

The average particle diameter of the third particles P3 is preferably 0.05 μm or more and 5.0 μm or less, more preferably 0.2 μm or more and 3.0 μm or less, and further more preferably 0.5 μm or more and 1.0 μm or less.

According to this, the fluidity and ease of handling of the solid composition P100 can be made more favorable. Further, in the functional ceramic molded body to be produced using the solid composition P100, the first functional ceramic and the second functional ceramic can be distributed in a more favorable form, and an undesirable variation in the formulation or the like in the functional ceramic molded body can be suppressed, and the denseness and reliability of the functional ceramic molded body can be made more excellent. Further, this is also advantageous from the viewpoint of improvement of the productivity of the solid composition P100 and reduction of the production cost.

When the average particle diameter of the first particles P1 is represented by D1 [μm] and the average particle diameter of the third particles P3 is represented by D3 [μm], it is preferred to satisfy a relationship: 0.01≤D3/D1≤2.0, it is more preferred to satisfy a relationship: 0.1≤D3/D1≤1.0, and it is further more preferred to satisfy a relationship: 0.3≤D3/D1≤0.5.

According to this, the precursor oxide and the oxoacid compound can be allowed to more favorably react with each other when producing the functional ceramic molded body. Further, in the solid composition P100, the occurrence of undesirable unevenness in the distribution of the respective particles can be more effectively prevented. As a result, undesirable unevenness in the formulation at the respective sites of the functional ceramic molded body to be produced using the solid composition P100 or the like can be more effectively prevented, and the denseness of the functional ceramic molded body can be further increased. In addition, the fluidity and ease of handling of the solid composition P100 can be made more favorable. Further, in the functional ceramic molded body to be produced using the solid composition P100, the first functional ceramic and the second functional ceramic can be distributed in a more favorable form, and an undesirable variation in the formulation or the like in the functional ceramic molded body can be suppressed, and the denseness and reliability of the functional ceramic molded body can be made more excellent.

In the solid composition P100 of this embodiment, the oxoacid compound is contained in the third particles P3.

In the drawing, the third particle P3 has a perfect spherical shape, but the shape of the third particle P3 is not limited thereto.

The third particles P3 need only contain the oxoacid compound, and may contain another component in addition to the oxoacid compound.

However, the content of the oxoacid compound in the third particles P3 is more than 50 mass %, and particularly, it is preferably 90.0 mass % or more, more preferably 95.0 mass % or more, and further more preferably 99.5 mass % or more.

The content of the oxoacid compound may be different in the plurality of third particles P3 constituting the solid composition P100. In such a case, as the value of the content of the oxoacid compound in the third particles P3, the average value of the contents of the oxoacid compound in the plurality of third particles P3 constituting the solid composition P100 shall be adopted. In other words, as the value of the content of the oxoacid compound in the third particles P3, the ratio of the total mass of the oxoacid compound to the mass of the assembly of all the third particles P3 constituting the solid composition P100 shall be adopted.

The solid composition P100 generally contains a plurality of third particles P3, but may contain, for example, the third particles P3 having mutually different conditions. For example, the solid composition P100 may contain the third particles P3 in which at least one of the particle diameter, shape, and formulation is different.

### [1-3] Second Functional Ceramic

The solid composition P100 contains the second functional ceramic.

The second functional ceramic may have any formulation as long as it functions itself as a functional ceramic, and may be, for example, an oxysulfide or an oxynitride, but is preferably an oxide.

According to this, generation of a poisonous gas is suppressed, and atmospheric stability is improved.

The second functional ceramic may have any crystal phase, and for example, a garnet-type oxide ceramic, a perovskite-type oxide ceramic, a NASICON-type oxide ceramic, and the like are exemplified.

Examples of the garnet-type oxide ceramic include an yttrium aluminum garnet ceramic, an yttrium iron garnet ceramic, cerium-doped yttrium aluminum garnet, and cerium-doped yttrium iron garnet.

Examples of the perovskite-type oxide ceramic include yttrium barium copper perovskite.

Further, when the second functional ceramic functions as a solid electrolyte, it is preferred that the second functional ceramic contains at least lithium.

In a case where the second functional ceramic functions as a solid electrolyte, when the second functional ceramic is a garnet-type oxide ceramic, the ion conductivity and mechanical strength of a solid electrolyte molded body as the functional ceramic molded body become more excellent. Further, the stability of the solid electrolyte molded body is improved, so that the safety of a battery to which the present disclosure is applied is enhanced.

In a case where the second functional ceramic functions as a solid electrolyte, when the second functional ceramic is a perovskite-type oxide ceramic, the firing when producing the functional ceramic molded body can be performed at a lower temperature.

In a case where the second functional ceramic functions as a solid electrolyte, when the second functional ceramic is a NASICON-type oxide ceramic, the atmospheric stability of a solid electrolyte molded body as the functional ceramic molded body is improved.

When the second functional ceramic functions as a solid electrolyte, as the garnet-type oxide ceramic that is the solid electrolyte, for example, Li₇La₃Zr₂O₇, and a material obtained by partially substituting the Li, La, and Zr sites thereof with any of various metals, for example, Li_{6.75}La₃Zr_{1.75}Ta_{0.25}O₇, Li_{6.3}La₃Zr_{1.3}Sb_{0.5}Ta_{0.2}O₇, Li_{6.7}Al_{0.1}La₃Zr₂O₇, and the like are exemplified.

When the second functional ceramic functions as a solid electrolyte, as the perovskite-type oxide ceramic that is the solid electrolyte, for example, La_{0.57}Li_{0.29}TiO₃ and the like are exemplified.

When the second functional ceramic functions as a solid electrolyte, as the NASICON-type oxide ceramic that is the solid electrolyte, for example, Li₁₊ₓAlₓTi₂₋ₓ(PO₄)₃ and the like are exemplified.

The content of the second functional ceramic in the solid composition P100 is not particularly limited, but is preferably 40 mass % or more and 95 mass % or less, more preferably 45 mass % or more and 90 mass % or less, and further more preferably 57 mass % or more and 83 mass % or less.

According to this, the functional ceramic molded body can be favorably obtained from the solid composition P100 by a heat treatment at a lower temperature for a shorter time while more reliably preventing the oxoacid compound from undesirably remaining in the functional ceramic molded body to be formed using the solid composition P100, and the desired property of the functional ceramic molded body to be obtained can be made particularly excellent.

When the content of the precursor oxide in the solid composition P100 is represented by XP [mass %] and the content of the second functional ceramic in the solid composition P100 is represented by X2 [mass %], it is preferred to satisfy a relationship: 0.05≤XP/X2≤1.20, it is more preferred to satisfy a relationship: 0.1≤XP/X2≤0.5, and it is further more preferred to satisfy a relationship: 0.2≤XP/X2≤0.3.

According to this, the denseness, reliability, and the like of the functional ceramic molded body to be produced using the solid composition P100 can be made more excellent.

The solid composition according to the present disclosure may contain multiple types of second functional ceramics. When the solid composition according to the present disclosure contains multiple types of second functional ceramics, as the value of the content of the second functional ceramic in the solid composition according to the present disclosure, the sum of the contents thereof shall be adopted.

In the solid composition P100 of this embodiment, the second functional ceramic is contained in the second particles P2.

For example, multiple types of second functional ceramics may be contained in a single second particle P2, or the solid composition P100 may contain different types of second functional ceramics to be contained as multiples types of second particles P2.

The average particle diameter of the second particles P2 is preferably 1.0 μm or more and 20 μm or less, more preferably 2.0 μm or more and 15 μm or less, and further more preferably 3.0 μm or more and 10 μm or less.

According to this, the fluidity and ease of handling of the solid composition P100 can be made more favorable. Further, in the functional ceramic molded body to be produced using the solid composition P100, the first functional ceramic and the second functional ceramic can be distributed in a more favorable form, and an undesirable variation in the formulation or the like in the functional ceramic molded body can be suppressed, and the denseness and reliability of the functional ceramic molded body can be made more excellent. Further, this is also advantageous from the viewpoint of improvement of the productivity of the solid composition P100 and reduction of the production cost.

When the average particle diameter of the first particles P1 is represented by D1 [μm] and the average particle diameter of the second particles P2 is represented by D2 [μm], it is preferred to satisfy a relationship: 0.1≤D2/D1≤20, it is more preferred to satisfy a relationship: 0.5≤D2/D1≤10, and it is further more preferred to satisfy a relationship: 1≤D2/D1≤5.

According to this, in the solid composition P100, the occurrence of undesirable unevenness in the distribution of the first particles P1 and the second particles P2 can be more effectively prevented. As a result, undesirable unevenness in the formulation at the respective sites of the functional ceramic molded body to be produced using the solid composition P100 or the like can be more effectively prevented, and the denseness of the functional ceramic molded body can be further increased. In addition, the fluidity and ease of handling of the solid composition P100 can be made more favorable. Further, in the functional ceramic molded body to be produced using the solid composition P100, the first functional ceramic and the second functional ceramic can be distributed in a more favorable form, and an undesirable variation in the formulation or the like in the functional ceramic molded body can be suppressed, and the denseness and reliability of the functional ceramic molded body can be made more excellent.

In the drawing, the second particle P2 has a perfect spherical shape, but the shape of the second particle P2 is not limited thereto.

The second particles P2 need only contain the second functional ceramic, and may contain another component in addition to the second functional ceramic.

However, the content of the second functional ceramic in the second particles P2 is more than 50 mass %, and particularly, it is preferably 90.0 mass % or more, more preferably 95.0 mass % or more, and further more preferably 99.5 mass % or more.

The content of the second functional ceramic may be different in the plurality of second particles P2 constituting the solid composition P100. In such a case, as the value of the content of the second functional ceramic in the second particles P2, the average value of the contents of the second functional ceramic in the plurality of second particles P2 constituting the solid composition P100 shall be adopted. In other words, as the value of the content of the second functional ceramic in the second particles P2, the ratio of the total mass of the second functional ceramic to the mass of the assembly of all the second particles P2 constituting the solid composition P100 shall be adopted.

The solid composition P100 generally includes a plurality of second particles P2, but may include, for example, the second particles P2 having mutually different conditions. For example, the solid composition P100 may include the second particles P2 in which at least one of the particle diameter, shape, and formulation is different.

### [1-4] Another Component

The solid composition according to the present disclosure contains the precursor oxide, the oxoacid compound, and the second functional ceramic as described above, but may further contain a component other than these. Hereinafter, among the components constituting the solid composition according to the present disclosure, a component other than the precursor oxide, the oxoacid compound, and the second functional ceramic is referred to as “another component”.

As such another component contained in the solid composition according to the present disclosure, for example, a solvent component used in the process for producing the solid composition according to the present disclosure, or the like is exemplified.

The content of such another component in the solid composition according to the present disclosure is not particularly limited, but is preferably 10 mass % or less, more preferably 5.0 mass % or less, further more preferably 0.5 mass % or less.

The solid composition according to the present disclosure may contain multiple types of components as such another component. In that case, as the value of the content of another component in the solid composition according to the present disclosure, the sum of the contents thereof shall be adopted.

The solid composition according to the present disclosure need only be in a solid form as a whole, and for example, may contain a liquid component such as a liquid component used in the production process therefor. However, in that case, the content of the liquid component in the solid composition is preferably 5.0 mass % or less, and more preferably 0.5 mass % or less.

### [2] Method for Producing Solid Composition

Next, a method for producing a solid composition according to the present disclosure will be described.

The method for producing a solid composition according to the present disclosure includes a precursor oxide production step of producing a precursor oxide that is an oxide to be converted into a first functional ceramic by reacting with an oxoacid compound, and a mixing step of mixing the precursor oxide, the oxoacid compound, and a second functional ceramic.

According to such a configuration, a method for producing a solid composition that can be favorably used in the production of a functional ceramic molded body having a high denseness and high reliability can be provided. More specifically, by containing an oxoacid compound, the melting point of the precursor oxide contained in the solid composition can be lowered, and the precursor oxide that is a constituent material of the solid composition can be converted into the first functional ceramic while promoting the crystal growth, and also the adhesion between the first functional ceramic and the second functional ceramic, or the like can be made excellent by a firing treatment that is a heat treatment at a relatively low temperature for a relatively short time. As a result, the functional ceramic molded body to be formed has a high denseness, achieves effective prevention of undesirable formulation change or crystal phase transition, or the like, and has high reliability. Further, while suppressing interface etching or generation of byproducts, the melting point of the oxide can be lowered, and the firing temperature or the joining temperature with a heterogeneous material can be lowered, and for example, the adhesion to an adherend can be made excellent even by a heat treatment at a relatively low temperature.

Hereinafter, the respective steps will be described in detail.

### [2-1] Precursor Oxide Production Step

In the precursor oxide production step, a precursor oxide to be converted into a first functional ceramic by reacting with an oxoacid compound is produced.

The precursor oxide may be produced by any method, however, it is preferably produced by subjecting a mixture containing multiple types of metal compounds as raw material substances, each containing a metal element constituting the precursor oxide in a molecule to a heat treatment.

According to this, the precursor oxide can be more stably obtained.

In particular, in this embodiment, the precursor oxide production step includes a metal compound solution preparation step of preparing a metal compound solution containing a metal compound including a metal element constituting the precursor oxide in a molecule and a solvent, a first heat treatment step of subjecting the metal compound solution to a first heat treatment, and a second heat treatment step of subjecting a composition obtained by the first heat treatment to a second heat treatment at a higher temperature than in the first heat treatment.

### [2-1-1] Metal Compound Solution Preparation Step

In the metal compound solution preparation step, a metal compound solution containing a metal compound including a metal element constituting the precursor oxide in a molecule and a solvent is prepared.

When the precursor oxide contains multiple types of metal elements, for example, the metal compound solution can be prepared by preparing solutions for each of the metal compounds corresponding to the respective metal elements, and mixing the resulting solutions.

Further, for example, the metal compound solution may be prepared by dissolving multiple types of metal compounds corresponding to two or more types of metal elements constituting the precursor oxide in the same solvent.

Further, for example, in the preparation of the metal compound solution, a metal compound containing two or more types of metal elements constituting the precursor oxide in a molecule may be used.

Further, two or more types of metal compounds may be used for the same metal element.

When the precursor oxide contains multiple types of metal elements, in this step, it is preferred that these respective metal elements are mixed at a ratio stoichiometrically corresponding to the formulation of a functional ceramic to be finally formed. Note that in place of the solution, a dispersion liquid may be used.

In this step, a lithium compound may be used as the metal compound, but it is preferred that a lithium compound is not used in this step.

Lithium is a highly volatile component among various types of metals. Therefore, by not using a lithium compound in this step, undesirable volatilization of lithium in a heat treatment step as described below, particularly, the second heat treatment step can be prevented, and the solid composition to be finally obtained or the functional ceramic molded body to be formed using the solid composition can be more reliably made to have a desired formulation.

Further, in the preparation of the metal compound solution, for example, in addition to the metal compound, the oxoacid compound may be used. Further, a compound containing an oxoanion may be used as the metal compound.

As the metal compound containing a metal element constituting the precursor oxide in a molecule, for example, compounds as follows can be used.

That is, as a lanthanum compound that is a metal compound as a lanthanum source, for example, a lanthanum metal salt, a lanthanum alkoxide, lanthanum hydroxide, and the like are exemplified, and among these, one type or two or more types in combination can be used. Examples of the lanthanum metal salt include lanthanum chloride, lanthanum nitrate, lanthanum sulfate, lanthanum acetate, and tris(2,4-pentanedionato)lanthanum. Examples of the lanthanum alkoxide include lanthanum trimethoxide, lanthanum triethoxide, lanthanum tripropoxide, lanthanum triisopropoxide, lanthanum tri-n-butoxide, lanthanum triisobutoxide, lanthanum tri-sec-butoxide, lanthanum tri-tert-butoxide, and dipivaloylmethanato lanthanum. Above all, the lanthanum compound is preferably at least one type selected from the group consisting of lanthanum nitrate, tris(2,4-pentanedionato)lanthanum, and lanthanum hydroxide. As the lanthanum source, a hydrate may be used.

As a zirconium compound that is a metal compound as a zirconium source, for example, a zirconium metal salt, a zirconium alkoxide, and the like are exemplified, and among these, one type or two or more types in combination can be used. Examples of the zirconium metal salt include zirconium chloride, zirconium oxychloride, zirconium oxynitrate, zirconium oxysulfate, zirconium oxyacetate, and zirconium acetate. Examples of the zirconium alkoxide include zirconium tetramethoxide, zirconium tetraethoxide, zirconium tetrapropoxide, zirconium tetraisopropoxide, zirconium tetra-n-butoxide, zirconium tetraisobutoxide, zirconium tetra-sec-butoxide, zirconium tetra-tert-butoxide, and dipivaloylmethanato zirconium. Above all, as the zirconium compound, zirconium tetra-n-butoxide is preferred. As the zirconium source, a hydrate may be used.

As a niobium compound that is a metal compound as a niobium source, for example, a niobium metal salt, a niobium alkoxide, niobium acetylacetone, and the like are exemplified, and among these, one type or two or more types in combination can be used. Examples of the niobium metal salt include niobium chloride, niobium oxychloride, and niobium oxalate. Examples of the niobium alkoxide include niobium ethoxide such as niobium pentaethoxide, niobium propoxide, niobium isopropoxide, and niobium sec-butoxide. Above all, as the niobium compound, niobium pentaethoxide is preferred. As the niobium source, a hydrate may be used.

As a tantalum compound that is a metal compound as a tantalum source, for example, a tantalum metal salt, a tantalum alkoxide, and the like are exemplified, and among these, one type or two or more types in combination can be used. Examples of the tantalum metal salt include tantalum chloride and tantalum bromide. Examples of the tantalum alkoxide include tantalum pentamethoxide, tantalum pentaethoxide, tantalum pentaisopropoxide, tantalum penta-n-propoxide, tantalum pentaisobutoxide, tantalum penta-n-butoxide, tantalum penta-sec-butoxide, and tantalum penta-tert-butoxide. Above all, as the tantalum compound, tantalum pentaethoxide is preferred. As the tantalum source, a hydrate may be used.

As an antimony compound that is a metal compound as an antimony source, for example, an antimony metal salt, an antimony alkoxide, and the like are exemplified, and among these, one type or two or more types in combination can be used. Examples of the antimony metal salt include antimony bromide, antimony chloride, and antimony fluoride. Examples of the antimony alkoxide include antimony trimethoxide, antimony triethoxide, antimony triisopropoxide, antimony tri-n-propoxide, and antimony tri-n-butoxide. Above all, as the antimony compound, antimony tri-n-butoxide is preferred. As the antimony source, a hydrate may be used.

As an yttrium compound as an yttrium source, for example, an yttrium metal salt, an yttrium alkoxide, and the like are exemplified, and among these, one type or two or more types in combination can be used. Examples of the yttrium metal salt include yttrium chloride, yttrium nitrate, yttrium sulfate, yttrium acetate, yttrium hydroxide, and yttrium carbonate. Further, examples of the yttrium alkoxide include yttrium methoxide, yttrium ethoxide, yttrium propoxide, yttrium isopropoxide, yttrium n-butoxide, yttrium isobutoxide, yttrium sec-butoxide, yttrium tert-butoxide, and dipivaloylmethanato yttrium. By using the yttrium compound as described above, as a functional ceramic, for example, YAG:Ce³⁺ to be used as a phosphor ceramic or the like, that is, cerium-doped yttrium aluminum garnet or YBCO to be used as a superconductor ceramic or the like, that is, yttrium barium copper perovskite can be favorably produced using the solid composition according to the present disclosure. Among these, as the yttrium compound, at least one of yttrium ethoxide and yttrium nitrate is preferred. As the yttrium source, a hydrate may be used.

As an aluminum compound as an aluminum source, for example, an aluminum metal salt, an aluminum alkoxide, and the like are exemplified, and among these, one type or two or more types in combination can be used. Examples of the aluminum metal salt include aluminum chloride, aluminum nitrate, aluminum sulfate, and aluminum acetate. Further, examples of the aluminum alkoxide include aluminum trimethoxide, aluminum triethoxide, aluminum tripropoxide, aluminum triisopropoxide, aluminum tri-n-butoxide, aluminum triisobutoxide, aluminum tri-sec-butoxide, aluminum tri-tert-butoxide, and dipivaloylmethanato aluminum. By using the aluminum compound as described above, as the functional ceramic, for example, YAG:Ce³⁺ to be used as a phosphor ceramic or the like, that is, cerium-doped yttrium aluminum garnet can be favorably produced using the solid composition according to the present disclosure. Among these, as the aluminum compound, at least one of aluminum nitrate and aluminum triisopropoxide is preferred. As the aluminum source, a hydrate may be used.

As a cerium compound as a cerium source, for example, a cerium metal salt, a cerium alkoxide, and the like are exemplified, and among these, one type or two or more types in combination can be used. Examples of the cerium metal salt include cerium chloride, cerium bromide, cerium nitrate, and cerium sulfate. Further, examples of the cerium alkoxide include cerium trimethoxide, cerium triethoxide, cerium triisopropoxide, cerium tri-n-propoxide, cerium triisobutoxide, cerium tri-n-butoxide, cerium tri-sec-butoxide, and cerium tri-tert-butoxide. By using the cerium compound as described above, as the functional ceramic, for example, YAG:Ce³⁺ to be used as a phosphor ceramic or the like, that is, cerium-doped yttrium aluminum garnet can be favorably produced using the solid composition according to the present disclosure. Among these, as the cerium compound, at least one of cerium nitrate and cerium triisopropoxide is preferred. As the cerium source, a hydrate may be used.

As a barium compound as a barium source, for example, a barium metal salt, an organic barium compound, and the like are exemplified, and among these, one type or two or more types in combination can be used. Examples of the barium metal salt include barium chloride, barium nitrate, barium sulfate, and barium acetate. Further, examples of the organic barium compound include barium dimethoxide, barium diethoxide, barium dipropoxide, barium diisopropoxide, barium di-n-butoxide, barium diisobutoxide, barium di-sec-butoxide, barium di-tert-butoxide, and dipivaloylmethanato barium. By using the barium compound as described above, as the functional ceramic, for example, YBCO to be used as a superconductor ceramic or the like, that is, yttrium barium copper perovskite can be favorably produced using the solid composition according to the present disclosure. Among these, as the barium compound, at least one of barium nitrate and barium diethoxide is preferred. As the barium source, a hydrate may be used.

As a copper compound as a copper source, for example, a copper metal salt and an organic copper compound are exemplified, and among these, one type or two or more types in combination can be used. Examples of the copper metal salt include copper chloride, copper bromide, copper nitrate, and copper sulfate. Further, examples of the organic copper compound include copper dimethoxide, copper diethoxide, copper diisopropoxide, copper di-n-propoxide, copper diisobutoxide, copper di-n-butoxide, copper di-sec-butoxide, copper di-tert-butoxide, and bis(dipivaloylmethanato)copper. By using the copper compound as described above, as the functional ceramic, for example, YBCO to be used as a superconductor ceramic or the like, that is, yttrium barium copper perovskite can be favorably produced using the solid composition according to the present disclosure. Among these, as the copper compound, at least one of copper nitrate and bis(dipivaloylmethanato)copper is preferred. As the copper source, a hydrate may be used.

The solvent is not particularly limited, and for example, various types of organic solvents can be used, however, more specifically, for example, an alcohol, a glycol, a ketone, an ester, an ether, an organic acid, an aromatic, an amide, and the like are exemplified, and one type or a mixed solvent that is a combination of two or more types selected from these can be used. Examples of the alcohol include methyl alcohol, ethyl alcohol, n-propyl alcohol, isopropyl alcohol, n-butyl alcohol, allyl alcohol, and 2-n-butoxyethanol. Examples of the glycol include ethylene glycol, propylene glycol, butylene glycol, hexylene glycol, pentanediol, hexanediol, heptanediol, and dipropylene glycol. Examples of the ketone include dimethyl ketone, methyl ethyl ketone, methyl propyl ketone, and methyl isobutyl ketone. Examples of the ester include methyl formate, ethyl formate, methyl acetate, and methyl acetoacetate. Examples of the ether include diethylene glycol monomethyl ether, diethylene glycol monoethyl ether, diethylene glycol dimethyl ether, ethylene glycol monomethyl ether, ethylene glycol monoethyl ether, and dipropylene glycol monomethyl ether. Examples of the organic acid include formic acid, acetic acid, 2-ethylbutyric acid, and propionic acid. Examples of the aromatic include toluene, o-xylene, and p-xylene. Examples of the amide include formamide, N,N-dimethylformamide, N,N-diethylformamide, dimethylacetamide, and N-methylpyrrolidone. Above all, the solvent is preferably at least one of 2-n-butoxyethanol and propionic acid.

### [2-1-2] First Heat Treatment Step

The metal compound solution prepared as described above is subjected to a first heat treatment. By doing this, the metal compound solution is generally gelled.

The conditions of the first heat treatment depend on the boiling point or the vapor pressure of the solvent or the like, but the heating temperature in the first heat treatment is preferably 50° C. or higher and 250° C. or lower, more preferably 60° C. or higher and 230° C. or lower, and further more preferably 80° C. or higher and 200° C. or lower. During the first heat treatment, the heating temperature may be changed. For example, the first heat treatment may include a first stage in which a heat treatment is performed while maintaining a relatively low temperature, and a second stage in which the temperature is raised after the first stage and a heat treatment at a relatively high temperature is performed. In such a case, it is preferred that the highest temperature in the first heat treatment falls within the above-mentioned range.

Further, the heating time in the first heat treatment is preferably 10 minutes or more and 180 minutes or less, more preferably 20 minutes or more and 120 minutes or less, and further more preferably 30 minutes or more and 60 minutes or less.

The first heat treatment may be performed in any atmosphere, and may be performed in an oxidizing atmosphere such as in the air or in an oxygen gas atmosphere, or may be performed in a non-oxidizing atmosphere of an inert gas such as nitrogen gas, helium gas, or argon gas, or the like. Further, the first heat treatment may be performed under reduced pressure or vacuum, or under pressure.

Further, during the first heat treatment, the atmosphere may be maintained under substantially the same conditions, or may be changed to different conditions. For example, the first heat treatment may include a first stage in which a heat treatment is performed in a normal pressure environment and a second stage in which a heat treatment is performed in a reduced pressure environment after the first stage.

### [2-1-3] Second Heat Treatment Step

Thereafter, the composition obtained by the first heat treatment, that is, the composition in a gel form is subjected to a second heat treatment.

By doing this, the precursor oxide is obtained.

Although the conditions of the second heat treatment depend on the formulation of the oxide to be formed or the like, the heating temperature in the second heat treatment need only be higher than the treatment temperature in the first heat treatment, and is preferably 400° C. or higher and 600° C. or lower, more preferably 430° C. or higher and 570° C. or lower, and further more preferably 450° C. or higher and 550° C. or lower. During the second heat treatment, the heating temperature may be changed. For example, the second heat treatment may include a first stage in which a heat treatment is performed while maintaining a relatively low temperature, and a second stage in which the temperature is raised after the first stage and a heat treatment is performed at a relatively high temperature. In such a case, it is preferred that the highest temperature in the second heat treatment falls within the above-mentioned range.

Further, the heating time in the second heat treatment is preferably 5 minutes or more and 180 minutes or less, more preferably 10 minutes or more and 120 minutes or less, and further more preferably 15 minutes or more and 60 minutes or less.

The second heat treatment may be performed in any atmosphere, and may be performed in an oxidizing atmosphere such as in the air or in an oxygen gas atmosphere, or may be performed in a non-oxidizing atmosphere of an inert gas such as nitrogen gas, helium gas, or argon gas, or the like. Further, the second heat treatment may be performed under reduced pressure or vacuum, or under pressure. In particular, the second heat treatment is preferably performed in an oxidizing atmosphere.

Further, during the second heat treatment, the atmosphere may be maintained under substantially the same conditions, or may be changed to different conditions. For example, the second heat treatment may include a first stage in which a heat treatment is performed in an inert gas atmosphere and a second stage in which a heat treatment is performed in an oxidizing atmosphere after the first stage.

The precursor oxide obtained as described above may be subjected to a treatment such as grinding or classification as needed.

### [2-2] Mixing Step

In the mixing step, the precursor oxide, the oxoacid compound, and the second functional ceramic are mixed.

By doing this, the solid composition according to the present disclosure containing the precursor oxide, the oxoacid compound, and the second functional ceramic is obtained.

As the oxoacid compound, for example, a compound described in the above [1-2] can be used. According to this, the same effect as described above is obtained.

As the second functional ceramic, for example, a compound described in the above [1-3] can be used. According to this, the same effect as described above is obtained.

The second functional ceramic can be obtained by, for example, preparing multiple types of metal compounds corresponding to the respective metal elements constituting the second functional ceramic, mixing these at a ratio corresponding to the constituent metal elements of the second functional ceramic, and firing the resulting mixture at a high temperature.

The metal elements constituting the metal compounds vary depending on the second functional ceramic to be produced.

As the metal compound, for example, a metal oxide, a metal salt, or the like can be used.

The firing temperature of the mixture is not particularly limited, but can be set to, for example, 1100° C. or higher and 1500° C. or lower.

Further, the second functional ceramic can be obtained by, for example, subjecting a composition containing a precursor oxide and an oxoacid compound obtained by the above-mentioned method to a firing treatment.

In that case, the heating temperature in the firing treatment is preferably 700° C. or higher and 1000° C. or lower, more preferably 730° C. or higher and 980° C. or lower, further more preferably 750° C. or higher and 950° C. or lower, and most preferably 780° C. or higher and 930° C. or lower.

The second functional ceramic obtained as described above may be subjected to a treatment such as grinding or classification as needed.

Further, the mixing in this step, that is, in the mixing step may be performed by a single stage, or may be performed by being divided into multiple stages. More specifically, for example, after a first treatment for obtaining a first mixture by performing mixing using two types of the precursor oxide, the oxoacid compound, and the second functional ceramic, a second treatment of mixing a component that is not contained in the first mixture among the precursor oxide, the oxoacid compound, and the second functional ceramic with the first mixture may be performed.

In this step, another component may be used other than the precursor oxide, the oxoacid compound, and the second functional ceramic.

Further, the mixing of the precursor oxide, the oxoacid compound, and the second functional ceramic may be performed by a dry process or a wet process. When the mixing is performed by a wet process, a step of removing a liquid component contained in the system may be performed after the mixing.

In the solid composition obtained in this manner, generally, almost all the liquid component such as a solvent used in the production process has been removed, however, a portion of the liquid component may remain therein. However, the content of the liquid component in the solid composition is preferably 1.0 mass % or less, and more preferably 0.1 mass % or less. Even if a small amount of a liquid component is contained in this manner, such a composition is in a solid form as a whole.

The solid composition according to the present disclosure obtained as described above is heated as described in detail later, particularly, heated at a higher temperature than in the above-mentioned second heat treatment, whereby the precursor oxide contained in the solid composition is converted into the first functional ceramic, and the functional ceramic molded body can be obtained.

Therefore, when the heat treatment for obtaining the functional ceramic molded body from the solid composition according to the present disclosure is regarded as main firing, the heat treatment for obtaining the precursor oxide, particularly, the above-mentioned second heat treatment can be referred to as calcination. Further, when the functional ceramic molded body obtained by the heat treatment which will be described in detail later is regarded as a main fired body, the precursor oxide can be referred to as a calcined body.

### [3] Method for Producing Functional Ceramic Molded Body

Next, a method for producing a functional ceramic molded body according to the present disclosure will be described.

The method for producing a functional ceramic molded body according to the present disclosure includes a molding step of obtaining a molded body using a solid composition obtained using the method for producing a solid composition according to the present disclosure described above, and a heat treatment step of subjecting the obtained molded body to a heat treatment so as to react the precursor oxide and the oxoacid compound in the solid composition to cause conversion to the first functional ceramic, thereby forming a functional ceramic molded body containing the first functional ceramic and the second functional ceramic.

According to this, a method for producing a functional ceramic molded body having a high denseness and high reliability can be provided. More specifically, by containing an oxoacid compound, the melting point of the precursor oxide contained in the solid composition can be lowered, and the precursor oxide that is a constituent material of the solid composition can be converted into a first functional ceramic while promoting the crystal growth, and also the adhesion between the first functional ceramic and the second functional ceramic, or the like can be made excellent by a firing treatment that is a heat treatment at a relatively low temperature for a relatively short time. As a result, the functional ceramic molded body to be formed has a high denseness, achieves effective prevention of undesirable formulation change or crystal phase transition, or the like, and has high reliability. Further, while suppressing interface etching or generation of byproducts, the melting point of the oxide can be lowered, and the firing temperature or the joining temperature with a heterogeneous material can be lowered, and for example, the adhesion to an adherend can be made excellent even by a heat treatment at a relatively low temperature.

### [3-1] Molding Step

In the molding step, a molded body is obtained using the solid composition according to the present disclosure described above.

In this step, the solid composition according to the present disclosure itself may be molded, or a mixture of the solid composition according to the present disclosure with another component may be molded.

As such another component, for example, a dispersion medium for dispersing the constituent particles of the solid composition according to the present disclosure, that is, the first particles P1 or the second particles P2, a binder, and the like are exemplified. Such a component can be used, for example, in the production of a molded body in a state of being mixed with the solid composition according to the present disclosure.

In particular, by using a dispersion medium, for example, a composition to be used in the production of the molded body, that is, a composition containing the solid composition according to the present disclosure can be formed into a paste or the like, so that the fluidity and ease of handling of the composition are improved, and the moldability of the molded body is improved.

However, the content of such another component in the composition to be used in the production of the molded body is preferably 20 mass % or less, more preferably 10 mass % or less, and further more preferably 5 mass % or less.

After obtaining the molded body using the solid composition according to the present disclosure, another component may be added to the molded body for the purpose of improving the stability of the shape of the molded body or the performance of the functional ceramic molded body to be produced using the method according to the present disclosure, or the like.

Further, in the molding step, multiple types of solid compositions according to the present disclosure may be combined and used. For example, multiple types of solid compositions, in which the conditions of at least one type of the precursor oxide, the oxoacid compound, and the second functional ceramic or the contents thereof are different may be mixed and used.

As the molding method for obtaining the molded body, various molding methods can be adopted, and for example, compression molding, extrusion molding, injection molding, various printing methods, various coating methods, and the like are exemplified.

The shape of the molded body obtained in this step is not particularly limited, but generally corresponds to the shape of the target functional ceramic molded body. Note that the molded body obtained in this step may have a different shape or size from that of the target functional ceramic molded body in consideration of a portion to be removed in the later step or a shrinkage or the like in the heat treatment step.

### [3-2] Heat Treatment Step

In the heat treatment step, a heat treatment is performed for the molded body obtained in the molding step. By doing this, the precursor oxide and the oxoacid compound are reacted with each other and converted into the first functional ceramic, whereby the functional ceramic molded body containing the first functional ceramic and the second functional ceramic is obtained.

The functional ceramic molded body obtained in this manner has excellent adhesion between the first functional ceramic and the second functional ceramic, or the like, and an undesirable void can be effectively prevented from occurring therebetween. Therefore, the functional ceramic molded body to be obtained has a high denseness and high reliability.

The heating temperature of the molded body in the heat treatment step is not particularly limited, but is preferably 700° C. or higher and 1000° C. or lower, more preferably 730° C. or higher and 980° C. or lower, and further more preferably 750° C. or higher and 950° C. or lower.

By performing heating at such a temperature, undesirable volatilization of a constituent component of the solid composition according to the present disclosure, particularly, a component which should constitute the functional ceramic molded body during heating can be more reliably prevented while making the denseness of the functional ceramic molded body to be obtained sufficiently high, and the functional ceramic molded body having a desired formulation can be more reliably obtained. Further, since the heating treatment is performed at a relatively low temperature, this is also advantageous from the viewpoint of energy saving, improvement of the productivity of the functional ceramic molded body, or the like.

In this step, the heating temperature may be changed. For example, this step may include a first stage in which a heat treatment is performed while maintaining a relatively low temperature, and a second stage in which the temperature is raised after the first stage and a heat treatment at a relatively high temperature is performed. In such a case, it is preferred that the highest temperature in this step falls within the above-mentioned range.

The heating time in this step is not particularly limited, but is preferably 5 minutes or more and 300 minutes or less, more preferably 10 minutes or more and 120 minutes or less, and further more preferably 15 minutes or more and 60 minutes or less.

According to this, the above-mentioned effect is more remarkably exhibited.

This step may be performed in any atmosphere, and may be performed in an oxidizing atmosphere such as in the air or in an oxygen gas atmosphere, or may be performed in a non-oxidizing atmosphere of an inert gas such as nitrogen gas, helium gas, or argon gas, or the like. Further, this step may be performed under reduced pressure or vacuum, or under pressure. In particular, this step is preferably performed in an oxidizing atmosphere.

Further, during this step, the atmosphere may be maintained under substantially the same conditions, or may be changed to different conditions.

The functional ceramic molded body obtained using the method for producing a functional ceramic molded body according to the present disclosure generally does not substantially contain the oxoacid compound contained in the solid composition according to the present disclosure used as a raw material. More specifically, the content of the oxoacid compound in the functional ceramic molded body obtained using the method for producing a functional ceramic molded body according to the present disclosure is generally 100 ppm or less, and particularly, it is preferably 50 ppm or less, and more preferably 10 ppm or less.

According to this, the content of an undesirable impurity in the functional ceramic molded body can be suppressed, and the properties and reliability of the functional ceramic molded body can be made more excellent.

The first functional ceramic formed in this step need only be different from the precursor oxide or the oxoacid compound that are the raw materials thereof, and may be different from the second functional ceramic or may be substantially the same as the second functional ceramic.

When the first functional ceramic and the second functional ceramic are substantially the same, the adhesion between the first functional ceramic and the second functional ceramic in the functional ceramic molded body can be improved, and the mechanical strength and the stability of the shape of the functional ceramic molded body, and the stability of the property and reliability of the functional ceramics, and the like can be made more excellent.

Here, the phrase “substantially the same” means that the formulation can be regarded as the same.

### [4] Functional Ceramic Molded Body

Next, the functional ceramic molded body obtained by the production method as described above will be described.

The function, type, intended use, or the like of the functional ceramic molded body is not particularly limited, however, for example, a solid electrolyte, a phosphor ceramic, a wavelength conversion ceramic, a magnetic ceramic, a superconductor ceramic, a dielectric ceramic, a catalytic ceramic, a thermoelectric ceramic, and the like are exemplified.

The functional ceramic molded body obtained as described above is preferably, for example, one that satisfies conditions as follows.

When the functional ceramic molded body is a phosphor ceramic, it is preferably a ceramic having high crystallinity and high sinterability so that an exciton generated by excitation light emits fluorescence without being trapped in a band that does not contribute to light emission derived from a crystal defect, and also the excitation light excites an activator without causing significant internal scattering.

According to this, a fluorescence source having high internal quantum efficiency and external extraction efficiency, and high fluorescence emission efficiency with respect to the excitation light is obtained.

Further, when the functional ceramic molded body is an oxide-based superconductor ceramic, it is preferably a ceramic having a few crystal defects, particularly, a few oxygen defects, and also having a low crystal grain boundary density, and further having a high crystal grain orientation.

According to this, the superconducting transition temperature Tc is increased, and also the critical current density Jc is improved, and therefore, a superconductive wire that allows a large current to flow at a relatively high temperature, or the like can be formed.

Further, when the functional ceramic molded body is a magnetic ceramic, a magnetic body having a higher saturation magnetization in a magnetic field bias is obtained as the oxygen deficiency in a crystal is less and the crystallinity is higher, and for example, a resonator having a higher Q value can be produced.

Further, when the functional ceramic molded body is used in an element designed so that a strong magnetic field can be applied by an appropriate electromagnet, a filter or a tuning circuit to which the property of a resonator having a high Q value is applied can be produced.

Further, when the functional ceramic molded body is a solid electrolyte, it is preferred to contain a lithium lanthanum zirconate-based solid electrolyte.

### [5] Secondary Battery

Next, a secondary battery to which the present disclosure is applied will be described.

A secondary battery according to the present disclosure is produced using the solid composition according to the present disclosure as described above, and can be produced by, for example, applying the method for producing a functional ceramic molded body according to the present disclosure described above.

Such a secondary battery has excellent charge-discharge characteristics.

### [5-1] Secondary Battery of First Embodiment

Hereinafter, a secondary battery according to a first embodiment will be described.

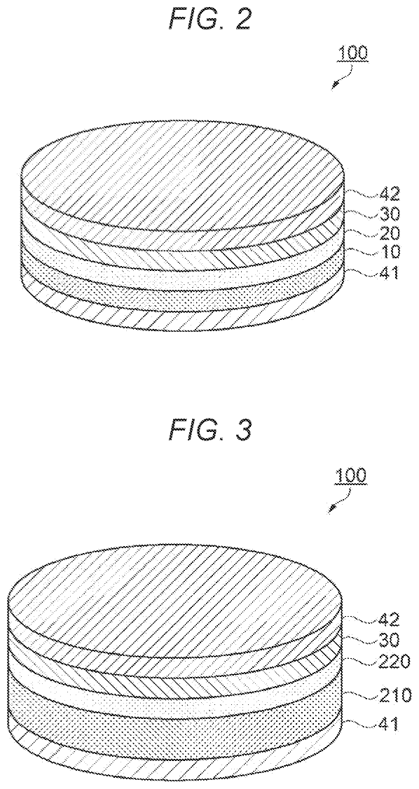

FIG. 2 is a schematic perspective view schematically showing a configuration of a lithium-ion battery as the secondary battery of the first embodiment.

As shown in FIG. 2, a lithium-ion battery 100 as the secondary battery includes a positive electrode 10, and a solid electrolyte layer 20 and a negative electrode 30, which are sequentially stacked on the positive electrode 10. The lithium-ion battery further includes a current collector 41 in contact with the positive electrode 10 at an opposite face side of the positive electrode 10 from a face thereof facing the solid electrolyte layer 20, and includes a current collector 42 in contact with the negative electrode 30 at an opposite face side of the negative electrode 30 from a face thereof facing the solid electrolyte layer 20. The positive electrode 10, the solid electrolyte layer 20, and the negative electrode 30 are all constituted by a solid phase, and therefore, the lithium-ion battery 100 is a chargeable and dischargeable all-solid-state secondary battery.

The shape of the lithium-ion battery 100 is not particularly limited, and may be, for example, a polygonal disk shape or the like, but is a circular disk shape in the configuration shown in the drawing. The size of the lithium-ion battery 100 is not particularly limited, but for example, the diameter of the lithium-ion battery 100 is, for example, 10 mm or more and 20 mm or less, and the thickness of the lithium-ion battery 100 is, for example, 0.1 mm or more and 1.0 mm or less.

When the lithium-ion battery 100 is small and thin in this manner, together with the fact that it is chargeable and dischargeable and is an all-solid-state battery, it can be favorably used as a power supply of a portable information terminal such as a smartphone. The lithium-ion battery 100 may be used for a purpose other than the power supply of a portable information terminal as described later.

Hereinafter, the respective configurations of the lithium-ion battery 100 will be described.

### [5-1-1] Solid Electrolyte Layer

The solid electrolyte layer 20 is formed using the solid composition according to the present disclosure described above.

According to this, the ion conductivity of the solid electrolyte layer 20 becomes excellent. Further, the adhesion of the solid electrolyte layer 20 to the positive electrode 10 or the negative electrode 30 can be made excellent. As a result, the properties and reliability of the lithium-ion battery 100 as a whole can be made particularly excellent.

The thickness of the solid electrolyte layer 20 is not particularly limited, but is preferably 0.3 μm or more and 1000 μm or less, and more preferably 0.5 μm or more and 100 or less from the viewpoint of charge-discharge rate.

Further, from the viewpoint of preventing a short circuit between the positive electrode 10 and the negative electrode 30 due to a lithium dendritic crystal body deposited at the negative electrode 30 side, a value obtained by dividing the measured weight of the solid electrolyte layer 20 by a value obtained by multiplying the apparent volume of the solid electrolyte layer 20 by the theoretical density of the solid electrolyte material, that is, the sintered density is preferably set to 50% or more, and more preferably set to 90% or more.

As a method for forming the solid electrolyte layer 20, for example, a green sheet method, a press firing method, a cast firing method, or the like is exemplified. A specific example of the method for forming the solid electrolyte layer 20 will be described in detail later. For the purpose of improving the adhesion of the solid electrolyte layer 20 to the positive electrode 10 and the negative electrode 30, or improving the output or battery capacity of the lithium-ion battery 100 by an increase in specific surface area, or the like, for example, a three-dimensional pattern structure such as a dimple, trench, or pillar pattern may be formed at a surface of the solid electrolyte layer 20 that comes in contact with the positive electrode 10 or the negative electrode 30.

### [5-1-2] Positive Electrode

The positive electrode 10 may be any as long as it is constituted by a positive electrode active material that can repeat electrochemical occlusion and release of lithium ions.

Specifically, as the positive electrode active material constituting the positive electrode 10, for example, a lithium composite oxide which contains at least Li and is constituted by any one or more types of elements selected from the group consisting of V, Cr, Mn, Fe, Co, Ni, and Cu, or the like can be used. Examples of such a composite oxide include LiCoO₂, LiNiO₂, LiMn₂O₄, Li₂Mn₂O₃, LiCr_{0.5}Mn_{0.5}O₂, LiFePO₄, Li₂FeP₂O₇, LiMnPO₄, LiFeBO₃, Li₃V₂ (PO₄)₃, Li₂CuO₂, Li₂FeSiO₄, and Li₂MnSiO₄. Further, as the positive electrode active material constituting the positive electrode 10, for example, a fluoride such as LiFeF₃, a boride complex compound such as LiBH₄ or Li₄BN₃H₁₀, an iodine complex compound such as a polyvinylpyridine-iodine complex, a nonmetallic compound such as sulfur, or the like can also be used.

The positive electrode 10 is preferably formed as a thin film at one surface of the solid electrolyte layer 20 in consideration of an electric conduction property and an ion diffusion distance.

The thickness of the positive electrode 10 formed of the thin film is not particularly limited, but is preferably 0.1 μm or more and 500 μm or less, and more preferably 0.3 μm or more and 100 μm or less.

As a method for forming the positive electrode 10, for example, a vapor phase deposition method such as a vacuum vapor deposition method, a sputtering method, a CVD method, a PLD method, an ALD method, or an aerosol deposition method, a chemical deposition method using a solution such as a sol-gel method or an MOD method, or the like is exemplified. In addition, for example, fine particles of the positive electrode active material are formed into a slurry together with an appropriate binder, followed by squeegeeing or screen printing, thereby forming a coating film, and then, the coating film may be baked onto the surface of the solid electrolyte layer 20 by drying and firing.

### [5-1-3] Negative Electrode

The negative electrode 30 may be any as long as it is constituted by a so-called negative electrode active material that repeats electrochemical occlusion and release of lithium ions at a lower potential than the material selected as the positive electrode 10.

Specifically, examples of the negative electrode active material constituting the negative electrode 30 include Nb₂O₅, V₂O₅, TiO₂, In₂O₃, ZnO, SnO₂, NiO, ITO, AZO, GZO, ATO, FTO, and lithium composite oxides such as Li₄Ti₅O₁₂ and Li₂Ti₃O₇. Further, additional examples thereof include metals and alloys such as Li, Al, Si, Si—Mn, Si—Co, Si—Ni, Sn, Zn, Sb, Bi, In, and Au, carbon materials, and materials obtained by intercalation of lithium ions between layers of a carbon material such as LiC₂₄ and LiC₆.

The negative electrode 30 is preferably formed as a thin film at one surface of the solid electrolyte layer 20 in consideration of an electric conduction property and an ion diffusion distance.

The thickness of the negative electrode 30 formed of the thin film is not particularly limited, but is preferably 0.1 μm or more and 500 μm or less, and more preferably 0.3 μm or more and 100 μm or less.

As a method for forming the negative electrode 30, for example, a vapor phase deposition method such as a vacuum vapor deposition method, a sputtering method, a CVD method, a PLD method, an ALD method, or an aerosol deposition method, a chemical deposition method using a solution such as a sol-gel method or an MOD method, or the like is exemplified. In addition, for example, fine particles of the negative electrode active material are formed into a slurry together with an appropriate binder, followed by squeegeeing or screen printing, thereby forming a coating film, and then, the coating film may be baked onto the surface of the solid electrolyte layer 20 by drying and firing.

### [5-1-4] Current Collector

The current collectors 41 and 42 are electric conductors provided so as to play a role in transfer of electrons to the positive electrode 10 or the negative electrode 30. As the current collector, generally, a current collector constituted by a material that has a sufficiently small electrical resistance, and that does not substantially change the electric conduction property or the mechanical structure thereof by charging and discharging is used. Specifically, as the constituent material of the current collector 41 of the positive electrode 10, for example, Al, Ti, Pt, Au, or the like is used. Further, as the constituent material of the current collector 42 of the negative electrode 30, for example, Cu or the like is favorably used.

The current collectors 41 and 42 are generally provided so that the contact resistance with the positive electrode 10 and the negative electrode 30 becomes small, respectively. Examples of the shape of each of the current collectors 41 and 42 include a plate shape and a mesh shape.

The thickness of each of the current collectors 41 and 42 is not particularly limited, but is preferably 7 μm or more and 85 μm or less, and more preferably 10 μm or more and 60 μm or less.

In the configuration shown in the drawing, the lithium-ion battery 100 includes a pair of current collectors 41 and 42, however, for example, when a plurality of lithium-ion batteries 100 are used by being stacked and electrically coupled to one another in series, the lithium-ion battery 100 may also be configured to include only the current collector 41 of the current collectors 41 and 42.

The lithium-ion battery 100 may be used for any purpose. Examples of an electronic device to which the lithium-ion battery 100 is applied as a power supply include a personal computer, a digital camera, a cellular phone, a smartphone, a music player, a tablet terminal, a timepiece, a smartwatch, various types of printers such as an inkjet printer, a television, a projector, wearable terminals such as a head-up display, wireless headphones, wireless earphones, smart glasses, and a head-mounted display, a video camera, a videotape recorder, a car navigation device, a drive recorder, a pager, an electronic notebook, an electronic dictionary, an electronic translation machine, an electronic calculator, an electronic gaming device, a toy, a word processor, a work station, a robot, a television telephone, a television monitor for crime prevention, electronic binoculars, a POS terminal, a medical device, a fish finder, various types of measurement devices, a device for mobile terminal base stations, various types of meters for vehicles, railroad cars, airplanes, helicopters, ships, or the like, a flight simulator, and a network server. Further, the lithium-ion battery 100 may be applied to, for example, moving objects such as a car and a ship. More specifically, it can be favorably applied as, for example, a storage battery for electric cars, plug-in hybrid cars, hybrid cars, fuel cell cars, or the like. In addition, it can also be applied to, for example, a power supply for household use, a power supply for industrial use, a storage battery for photovoltaic power generation, or the like.

### [5-2] Secondary Battery of Second Embodiment

Next, a secondary battery according to a second embodiment will be described.

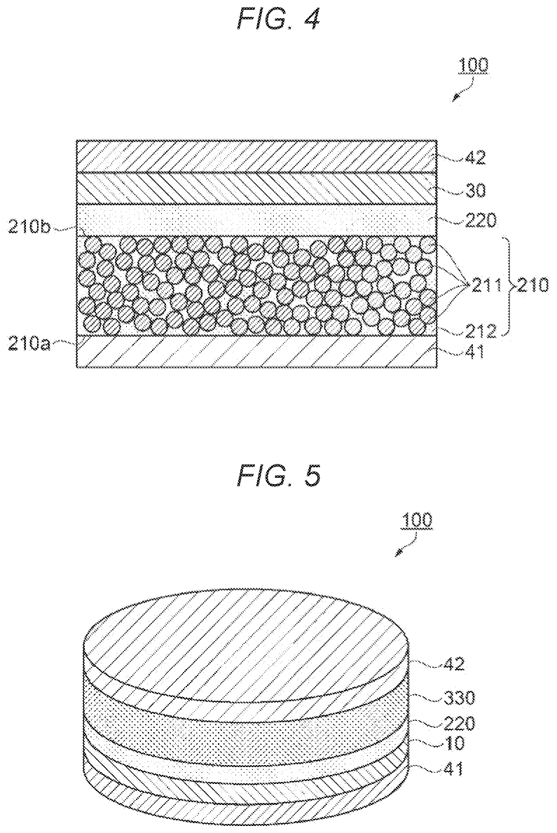

FIG. 3 is a schematic perspective view schematically showing a configuration of a lithium-ion battery as the secondary battery of the second embodiment, and FIG. 4 is a schematic cross-sectional view schematically showing a structure of the lithium-ion battery as the secondary battery of the second embodiment.

Hereinafter, the secondary battery according to the second embodiment will be described with reference to these drawings, but different points from the above-mentioned embodiment will be mainly described, and the description of the same matter will be omitted.

As shown in FIG. 3, a lithium-ion battery 100 as the secondary battery of this embodiment includes a positive electrode composite material 210 that functions as a positive electrode, and an electrolyte layer 220 and a negative electrode 30, which are sequentially stacked on the positive electrode composite material 210. The lithium-ion battery further includes a current collector 41 in contact with the positive electrode composite material 210 at an opposite face side of the positive electrode composite material 210 from a face thereof facing the electrolyte layer 220, and includes a current collector 42 in contact with the negative electrode 30 at an opposite face side of the negative electrode 30 from a face thereof facing the electrolyte layer 220.

Hereinafter, the positive electrode composite material 210 and the electrolyte layer 220 which are different from the configuration of the lithium-ion battery 100 according to the above-mentioned embodiment will be described.

### [5-2-1] Positive Electrode Composite Material

As shown in FIG. 4, the positive electrode composite material 210 in the lithium-ion battery 100 of this embodiment includes a positive electrode active material 211 in a particulate shape and a solid electrolyte 212. In such a positive electrode composite material 210, the battery reaction rate in the lithium-ion battery 100 can be further increased by increasing an interfacial area where the positive electrode active material 211 in a particulate shape and the solid electrolyte 212 are in contact with each other.

The average particle diameter of the positive electrode active material 211 is not particularly limited, but is preferably 0.1 μm or more and 150 μm or less, and more preferably 0.3 μm or more and 60 μm or less.

According to this, it becomes easy to achieve both an actual capacity density close to the theoretical capacity of the positive electrode active material 211 and a high charge-discharge rate.

Note that in this specification, the average particle diameter refers to a volume-based average particle diameter, and can be determined by, for example, subjecting a dispersion liquid prepared by adding a sample to methanol and dispersing the sample for 3 minutes using an ultrasonic disperser to measurement with a particle size distribution analyzer according to the Coulter counter method (model TA-II, manufactured by Coulter Electronics, Inc.) using an aperture of 50 μm.

The particle size distribution of the positive electrode active material 211 is not particularly limited, and for example, in the particle size distribution having one peak, the half width of the peak can be set to 0.15 μm or more and 19 μm or less. Further, the particle size distribution of the positive electrode active material 211 may have two or more peaks.

In FIG. 4, the shape of the positive electrode active material 211 in a particulate shape is shown as a spherical shape, however, the shape of the positive electrode active material 211 is not limited to a spherical shape, and it can have various shapes, for example, a columnar shape, a plate shape, a scaly shape, a hollow shape, an indefinite shape, and the like, and further, two or more types among these may be mixed.

Examples of the positive electrode active material 211 include the same materials as exemplified as the constituent material of the positive electrode 10 in the above-mentioned first embodiment.

In the positive electrode active material 211, for example, a coating layer may be formed at a surface for the purpose of reducing the interface resistance between the positive electrode active material 211 and the solid electrolyte 212, or improving an electron conduction property, or the like. For example, by forming a thin film of LiNbO₃, Al₂O₃, ZrO₂, Ta₂O₅, or the like at a surface of a particle of the positive electrode active material 211 composed of LiCoO₂, the interface resistance of lithium ion conduction can be further reduced. The thickness of the coating layer is not particularly limited, but is preferably 3 nm or more and 1 or less.

In this embodiment, the positive electrode composite material 210 includes the solid electrolyte 212 in addition to the positive electrode active material 211 described above. The solid electrolyte 212 is present so as to fill up a gap between particles of the positive electrode active material 211 or so as to be in contact with, particularly in close contact with the surface of the positive electrode active material 211.

The solid electrolyte 212 is formed using the solid composition according to the present disclosure described above.

According to this, the ion conductivity of the solid electrolyte 212 becomes particularly excellent. Further, the adhesion of the solid electrolyte 212 to the positive electrode active material 211 or the electrolyte layer 220 becomes excellent. Accordingly, the properties and reliability of the lithium-ion battery 100 as a whole can be made particularly excellent.

When the content of the positive electrode active material 211 in the positive electrode composite material 210 is represented by XA [mass %] and the content of the solid electrolyte 212 in the positive electrode composite material 210 is represented by XS [mass %], it is preferred to satisfy a relationship: 0.1≤XS/XA≤8.3, it is more preferred to satisfy a relationship: 0.3≤XS/XA≤2.8, and it is further more preferred to satisfy a relationship: 0.6≤XS/XA≤1.4.

Further, the positive electrode composite material 210 may include an electric conduction assistant, a binder, or the like other than the positive electrode active material 211 and the solid electrolyte 212.

As the electric conduction assistant, any material may be used as long as it is an electric conductor whose electrochemical interaction can be ignored at a positive electrode reaction potential, and more specifically, for example, a carbon material such as acetylene black, Ketjen black, or a carbon nanotube, a noble metal such as palladium or platinum, an electric conductive oxide such as SnO₂, ZnO, RuO₂, ReO₃, or Ir₂O₃, or the like can be used.

The thickness of the positive electrode composite material 210 is not particularly limited, but is preferably 0.1 μm or more and 500 μm or less, and more preferably 0.3 μm or more and 100 μm or less.

### [5-2-2] Electrolyte Layer

The electrolyte layer 220 is preferably constituted by the same material or the same type of material as the solid electrolyte 212 from the viewpoint of an interfacial impedance between the electrolyte layer 220 and the positive electrode composite material 210, but may be constituted by a material different from the solid electrolyte 212. For example, the electrolyte layer 220 is formed using the solid composition according to the present disclosure described above, but may be constituted by a material having a different formulation from the solid electrolyte 212. Further, the electrolyte layer 220 may be a crystalline material or an amorphous material of another oxide solid electrolyte which is not formed using the solid composition according to the present disclosure, a sulfide solid electrolyte, a nitride solid electrolyte, a halide solid electrolyte, a hydride solid electrolyte, a dry polymer electrolyte, or a quasi-solid electrolyte, or may be constituted by a material in which two or more types selected from these are combined.

Examples of a crystalline oxide include Li_{0.35}La_{0.55}TiO₃, Li_{0.2}La_{0.27}NbO₃, and a perovskite-type crystal or a perovskite-like crystal in which the elements constituting a crystal thereof are partially substituted with N, F, Al, Sr, Sc, Nb, Ta, Sb, a lanthanoid element, or the like, Li₇La₃Zr₂O₁₂, Li₅La₃Nb₂O₁₂, Li₅BaLa₂TaO₁₂, and a garnet-type crystal or a garnet-like crystal in which the elements constituting a crystal thereof are partially substituted with N, F, Al, Sr, Sc, Nb, Ta, Sb, a lanthanoid element, or the like, Li_{1.3}Ti_{1.7}Al_{0.3} (PO₄)₃, Li_{1.4}Al_{0.4}Ti_{1.6} (PO₄)₃, Li_{1.4}Al_{0.4}Ti_{1.4}Ge_{0.2} (PO₄)₃, and a NASICON-type crystal in which the elements constituting a crystal thereof are partially substituted with N, F, Al, Sr, Sc, Nb, Ta, Sb, a lanthanoid element, or the like, a LISICON-type crystal such as Li₁₄ZnGe₄O₁₆, and other crystalline materials such as Li_{3.4}V_{0.6}Si_{0.4}O₄, Li_{3.6}V_{0.4}Ge_{0.6}O₄ and Li₂₊ₓC₁₋ₓBₓO₃.

Examples of a crystalline sulfide include Li₁₀GeP₂S₁₂, Li_{9.6}P₃S₁₂, Li_{9.54}Si_{1.74}P_{1.44}S_{11.7}Cl_{0.3}, and Li₃PS₄.

Examples of other amorphous materials include Li₂O—TiO₂, La₂O₃—Li₂O—TiO₂, LiNbO₃, LiSO₄, Li₄SiO₄, Li₃PO₄—Li₄SiO₄, Li₄GeO₄—Li₃VO₄, Li₄S₃VO₄, Li₄GeO₄—Zn₂GeO₂, Li₄SiO₄—LiMoO₄, Li₄SiO₄—Li₄ZrO₄, SiO₂—P₂O₅—Li₂O, SiO₂—P₂O₅—LiCl, Li₂O—LiCl—B₂O₃, LiAlCl₄, LiAlF₄, LiF—Al₂O₃, LiBr—Al₂O₃, Li_{2.88}PO_{3.73}N_{0.14}, Li₃N—LiCl, Li₆NBr₃, Li₂S—SiS₂, and Li₂S—SiS₂—P₂S₅.

When the electrolyte layer 220 is constituted by a crystalline material, the crystalline material preferably has a crystal structure such as a cubic crystal having small crystal plane anisotropy in the direction of lithium ion conduction. Further, when the electrolyte layer 220 is constituted by an amorphous material, the anisotropy in lithium ion conduction becomes small. Therefore, the crystalline material and the amorphous material as described above are both preferred as a solid electrolyte constituting the electrolyte layer 220.

The thickness of the electrolyte layer 220 is preferably 0.1 μm or more and 100 μm or less, and more preferably 0.2 μm or more and 10 μm or less. When the thickness of the electrolyte layer 220 is a value within the above range, the internal resistance of the electrolyte layer 220 can be further decreased, and also the occurrence of a short circuit between the positive electrode composite material 210 and the negative electrode 30 can be more effectively prevented.

For the purpose of improving the adhesion between the electrolyte layer 220 and the negative electrode 30, or improving the output or battery capacity of the lithium-ion battery 100 by an increase in specific surface area, or the like, for example, a three-dimensional pattern structure such as a dimple, trench, or pillar pattern may be formed at a surface of the electrolyte layer 220 that comes in contact with the negative electrode 30.

### [5-3] Secondary Battery of Third Embodiment

Next, a secondary battery according to a third embodiment will be described.

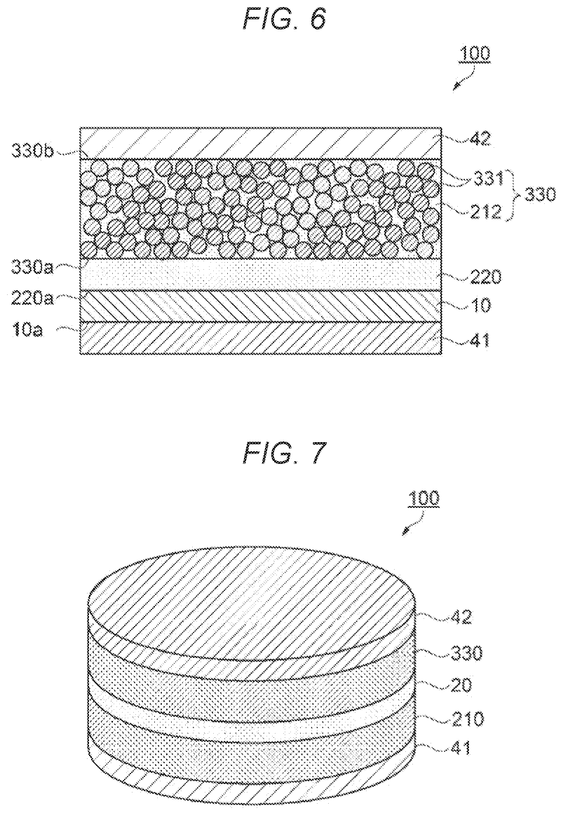

FIG. 5 is a schematic perspective view schematically showing a configuration of a lithium-ion battery as the secondary battery of the third embodiment, and FIG. 6 is a schematic cross-sectional view schematically showing a structure of the lithium-ion battery as the secondary battery of the third embodiment.

Hereinafter, the secondary battery according to the third embodiment will be described with reference to these drawings, but different points from the above-mentioned embodiments will be mainly described, and the description of the same matter will be omitted.

As shown in FIG. 5, a lithium-ion battery 100 as the secondary battery of this embodiment includes a positive electrode 10, and an electrolyte layer 220 and a negative electrode composite material 330 that functions as a negative electrode, which are sequentially stacked on the positive electrode 10. The lithium-ion battery further includes a current collector 41 in contact with the positive electrode 10 at an opposite face side of the positive electrode 10 from a face thereof facing the electrolyte layer 220, and includes a current collector 42 in contact with the negative electrode composite material 330 at an opposite face side of the negative electrode composite material 330 from a face thereof facing the electrolyte layer 220.

Hereinafter, the negative electrode composite material 330 which is different from the configuration of the lithium-ion battery 100 according to the above-mentioned embodiments will be described.

### [5-3-1] Negative Electrode Composite Material

As shown in FIG. 6, the negative electrode composite material 330 in the lithium-ion battery 100 of this embodiment includes a negative electrode active material 331 in a particulate shape and a solid electrolyte 212. In such a negative electrode composite material 330, the battery reaction rate in the lithium-ion battery 100 can be further increased by increasing an interfacial area where the negative electrode active material 331 in a particulate shape and the solid electrolyte 212 are in contact with each other.

The average particle diameter of the negative electrode active material 331 is not particularly limited, but is preferably 0.1 μm or more and 150 μm or less, and more preferably 0.3 μm or more and 60 μm or less.

According to this, it becomes easy to achieve both an actual capacity density close to the theoretical capacity of the negative electrode active material 331 and a high charge-discharge rate.

The particle size distribution of the negative electrode active material 331 is not particularly limited, and for example, in the particle size distribution having one peak, the half width of the peak can be set to 0.1 μm or more and 18 or less. Further, the particle size distribution of the negative electrode active material 331 may have two or more peaks.

In FIG. 6, the shape of the negative electrode active material 331 in a particulate shape is shown as a spherical shape, however, the shape of the negative electrode active material 331 is not limited to a spherical shape, and it can have various shapes, for example, a columnar shape, a plate shape, a scaly shape, a hollow shape, an indefinite shape, and the like, and further, two or more types among these may be mixed.

Examples of the negative electrode active material 331 include the same materials as exemplified as the constituent material of the negative electrode 30 in the above-mentioned first embodiment.

In this embodiment, the negative electrode composite material 330 includes the solid electrolyte 212 in addition to the negative electrode active material 331 described above. The solid electrolyte 212 is present so as to fill up a gap between particles of the negative electrode active material 331 or so as to be in contact with, particularly in close contact with the surface of the negative electrode active material 331.

The solid electrolyte 212 is formed using the solid composition according to the present disclosure described above.

According to this, the ion conductivity of the solid electrolyte 212 becomes particularly excellent. Further, the adhesion of the solid electrolyte 212 to the negative electrode active material 331 or the electrolyte layer 220 can be made excellent. Accordingly, the properties and reliability of the lithium-ion battery 100 as a whole can be made particularly excellent.

When the content of the negative electrode active material 331 in the negative electrode composite material 330 is represented by XB [mass %] and the content of the solid electrolyte 212 in the negative electrode composite material 330 is represented by XS [mass %], it is preferred to satisfy a relationship: 0.14≤XS/XB≤26, it is more preferred to satisfy a relationship: 0.44≤XS/XB≤4.1, and it is further more preferred to satisfy a relationship: 0.89≤XS/XB≤2.1.

Further, the negative electrode composite material 330 may include an electric conduction assistant, a binder, or the like other than the negative electrode active material 331 and the solid electrolyte 212.

As the electric conduction assistant, any material may be used as long as it is an electric conductor whose electrochemical interaction can be ignored at a negative electrode reaction potential, and more specifically, for example, a carbon material such as acetylene black, Ketjen black, or a carbon nanotube, a noble metal such as palladium or platinum, an electric conductive oxide such as SnO₂, ZnO, RuO₂, ReO₃, or Ir₂O₃, or the like can be used.

The thickness of the negative electrode composite material 330 is not particularly limited, but is preferably 0.1 μm or more and 500 μm or less, and more preferably 0.3 μm or more and 100 μm or less.

### [5-4] Secondary Battery of Fourth Embodiment

Next, a secondary battery according to a fourth embodiment will be described.

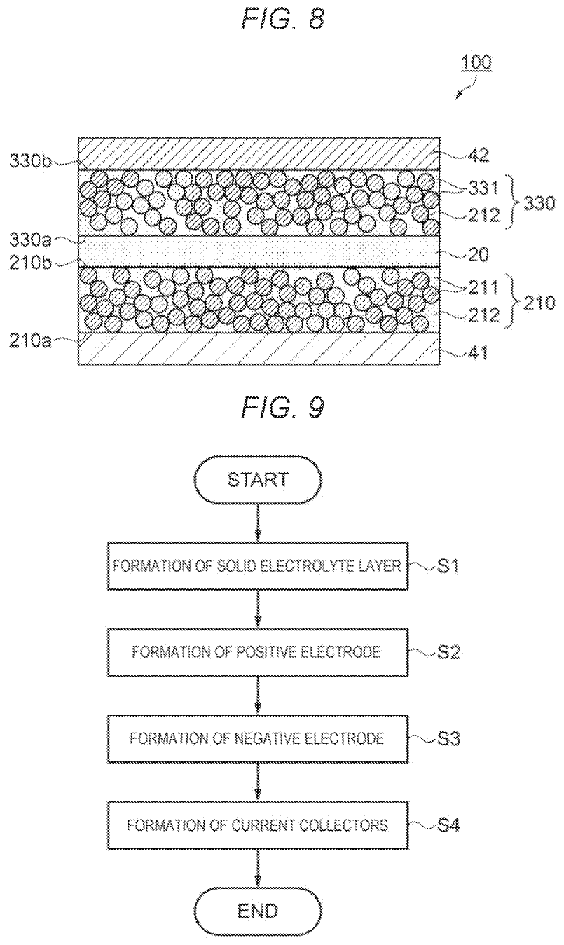

FIG. 7 is a schematic perspective view schematically showing a configuration of a lithium-ion battery as the secondary battery of the fourth embodiment, and FIG. 8 is a schematic cross-sectional view schematically showing a structure of the lithium-ion battery as the secondary battery of the fourth embodiment.

Hereinafter, the secondary battery according to the fourth embodiment will be described with reference to these drawings, but different points from the above-mentioned embodiments will be mainly described, and the description of the same matter will be omitted.

As shown in FIG. 7, a lithium-ion battery 100 as the secondary battery of this embodiment includes a positive electrode composite material 210, and a solid electrolyte layer 20 and a negative electrode composite material 330, which are sequentially stacked on the positive electrode composite material 210. The lithium-ion battery further includes a current collector 41 in contact with the positive electrode composite material 210 at an opposite face side of the positive electrode composite material 210 from a face thereof facing the solid electrolyte layer 20, and includes a current collector 42 in contact with the negative electrode composite material 330 at an opposite face side of the negative electrode composite material 330 from a face thereof facing the solid electrolyte layer 20.

It is preferred that the respective portions satisfy the same conditions as described for the respective corresponding portions in the above-mentioned embodiments.

In the first to fourth embodiments, another layer may be provided between layers or at a surface of a layer of the respective layers constituting the lithium-ion battery 100. Examples of such a layer include an adhesive layer, an insulating layer, and a protective layer.

### [6] Method for Producing Secondary Battery

Next, a method for producing the above-mentioned secondary battery will be described.

### [6-1] Method for Producing Secondary Battery of First Embodiment

Hereinafter, a method for producing the secondary battery according to the first embodiment will be described.

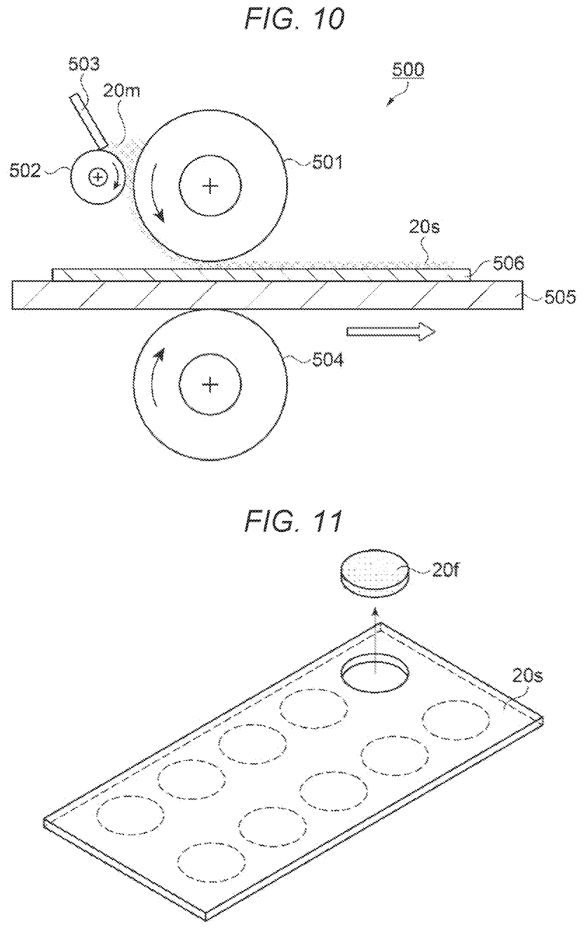

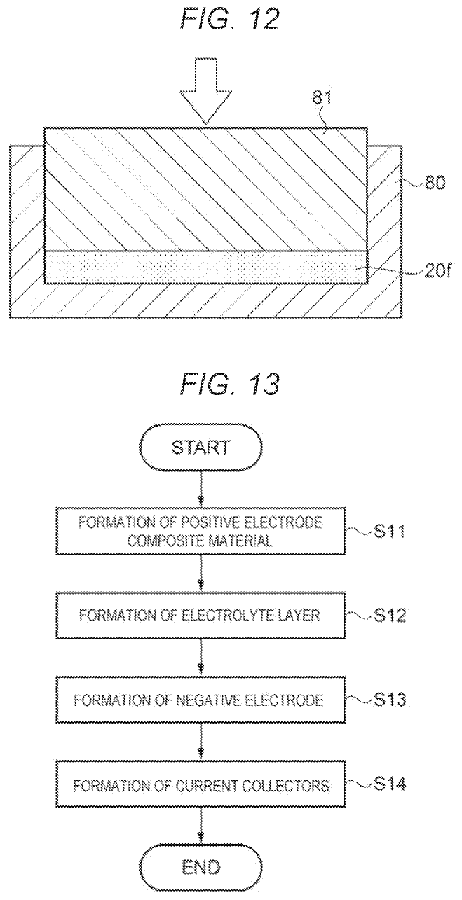

FIG. 9 is a flowchart showing the method for producing the lithium-ion battery as the secondary battery of the first embodiment, FIGS. 10 and 11 are schematic views schematically showing the method for producing the lithium-ion battery as the secondary battery of the first embodiment, and FIG. 12 is a schematic cross-sectional view schematically showing another method for forming a solid electrolyte layer.

As shown in FIG. 9, the method for producing the lithium-ion battery 100 of this embodiment includes Step S1, Step S2, Step S3, and Step S4.

Step S1 is a step of forming the solid electrolyte layer 20. Step S2 is a step of forming the positive electrode 10. Step S3 is a step of forming the negative electrode 30. Step S4 is a step of forming the current collectors 41 and 42.

### [6-1-1] Step S1

In the step of forming the solid electrolyte layer 20 of Step S1, the solid electrolyte layer 20 is formed by, for example, a green sheet method using the solid composition according to the present disclosure. More specifically, the solid electrolyte layer 20 can be formed as follows.

That is, first, for example, a solution in which a binder such as polypropylene carbonate is dissolved in a solvent such as 1,4-dioxane is prepared, and the solution and the solid composition according to the present disclosure are mixed, whereby a slurry 20m is obtained. In the preparation of the slurry 20m, a dispersant, a diluent, a humectant, or the like may be further used as needed.

Subsequently, by using the slurry 20m, a solid electrolyte layer forming sheet 20s is formed. More specifically, as shown in FIG. 10, for example, by using a fully automatic film applicator 500, the slurry 20m is applied to a predetermined thickness onto the base material 506 such as a polyethylene terephthalate film, whereby the solid electrolyte layer forming sheet 20s is formed. The fully automatic film applicator 500 includes an application roller 501 and a doctor roller 502. A squeegee 503 is provided so as to come in contact with the doctor roller 502 from above. A conveyance roller 504 is provided below the application roller 501 at a position opposite thereto, and a stage 505 on which the base material 506 is placed is conveyed in a fixed direction by inserting the stage 505 between the application roller 501 and the conveyance roller 504. The slurry 20m is fed to a side where the squeegee 503 is provided between the application roller 501 and the doctor roller 502 disposed with a gap therebetween in the conveyance direction of the stage 505. The slurry 20m with a predetermined thickness is applied to the surface of the application roller 501 by rotating the application roller 501 and the doctor roller 502 so as to extrude the slurry 20m downward from the gap. Then, along with this, by rotating the conveyance roller 504, the stage 505 is conveyed so that the base material 506 comes in contact with the application roller 501 to which the slurry 20m has been applied. By doing this, the slurry 20m applied to the application roller 501 is transferred in a sheet form to the base material 506, whereby the solid electrolyte layer forming sheet 20s is formed.

Thereafter, the solvent is removed from the solid electrolyte layer forming sheet 20s formed on the base material 506, and the solid electrolyte layer forming sheet 20s is detached from the base material 506 and punched to a predetermined size using a punching die as shown in FIG. 11, whereby a molded material 20f is formed.

Thereafter, the molded material 20f is subjected to a heating step at a temperature of 700° C. or higher and 1000° C. or lower, whereby the solid electrolyte layer 20 as a main fired body is obtained. The heating time and atmosphere in the heating step are as described above.

The solid electrolyte layer forming sheet 20s with a predetermined thickness may be formed by pressing and extruding the slurry 20m by the application roller 501 and the doctor roller 502 so that the sintered density of the solid electrolyte layer 20 after firing becomes 90% or more.

### [6-1-2] Step S2

After Step S1, the process proceeds to Step S2.

In the step of forming the positive electrode 10 of Step S2, the positive electrode 10 is formed at one face of the solid electrolyte layer 20. More specifically, for example, first, by using a sputtering device, sputtering is performed using LiCoO₂ as a target in an inert gas such as argon gas, whereby a LiCoO₂ layer is formed at a surface of the solid electrolyte layer 20. Thereafter, the LiCoO₂ layer formed on the solid electrolyte layer 20 is fired in an oxidizing atmosphere so as to convert the crystal of the LiCoO₂ layer into a high-temperature phase crystal, whereby the LiCoO₂ layer can be converted into the positive electrode 10. The firing conditions of the LiCoO₂ layer are not particularly limited, but the heating temperature can be set to 400° C. or higher and 600° C. or lower, and the heating time can be set to 1 hour or more and 3 hours or less.

### [6-1-3] Step S3

After Step S2, the process proceeds to Step S3.

In the step of forming the negative electrode 30 of Step S3, the negative electrode 30 is formed at the other face of the solid electrolyte layer 20, that is, a face at an opposite side from the face at which the positive electrode 10 is formed. More specifically, for example, by using a vacuum deposition device or the like, the negative electrode 30 can be formed by forming a thin film of metal Li at a face of the solid electrolyte layer 20 at an opposite side from the face at which the positive electrode 10 is formed. The thickness of the negative electrode 30 can be set to, for example, 0.1 μm or more and 500 μm or less.

### [6-1-4] Step S4

After Step S3, the process proceeds to Step S4.

In the step of forming the current collectors 41 and 42 of Step S4, the current collector 41 is formed so as to come in contact with the positive electrode 10, and the current collector 42 is formed so as to come in contact with the negative electrode 30. More specifically, for example, an aluminum foil formed into a circular shape by punching or the like is joined to the positive electrode 10 by pressing, whereby the current collector 41 can be formed. Further, for example, a copper foil formed into a circular shape by punching or the like is joined to the negative electrode 30 by pressing, whereby the current collector 42 can be formed. The thickness of each of the current collectors 41 and 42 is not particularly limited, but can be set to, for example, 10 μm or more and 60 μm or less. In this step, only one of the current collectors 41 and 42 may be formed.

The method for forming the solid electrolyte layer 20 is not limited to the green sheet method shown in Step S1. As another method for forming the solid electrolyte layer 20, for example, a method as described below can be adopted. That is, as shown in FIG. 12, the molded material 20f may be obtained by filling the solid composition according to the present disclosure in a powder form in a pellet die 80, closing the pellet die using a lid 81, and pressing the lid 81 to perform uniaxial press molding. A treatment for the molded material 20f thereafter can be performed in the same manner as described above. As the pellet die 80, a die including an exhaust port (not shown) can be favorably used.

### [6-2] Method for Producing Secondary Battery of Second Embodiment

Next, a method for producing the secondary battery according to the second embodiment will be described.

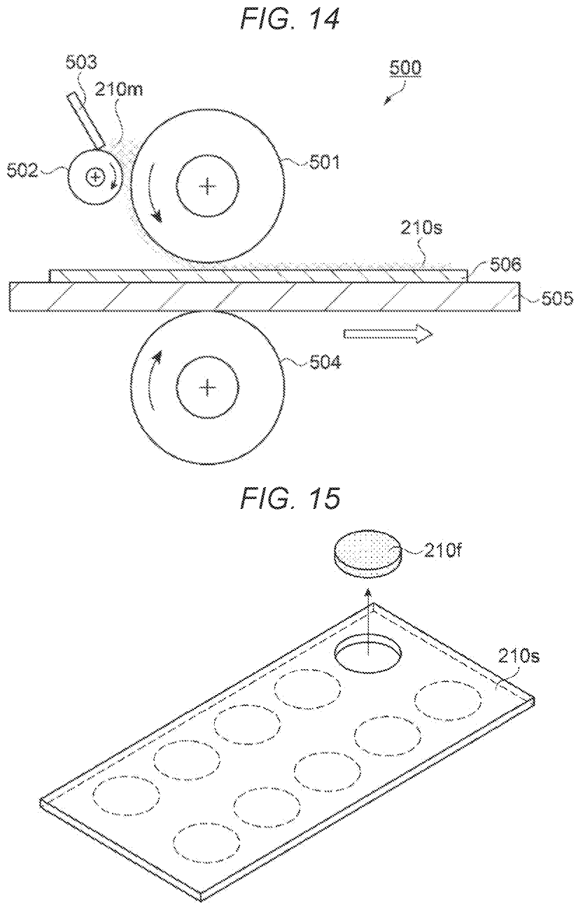

FIG. 13 is a flowchart showing the method for producing the lithium-ion battery as the secondary battery of the second embodiment, and FIGS. 14 and 15 are schematic views schematically showing the method for producing the lithium-ion battery as the secondary battery of the second embodiment.

Hereinafter, the method for producing the secondary battery according to the second embodiment will be described with reference to these drawings, but different points from the above-mentioned embodiment will be mainly described, and the description of the same matter will be omitted.

As shown in FIG. 13, the method for producing the lithium-ion battery 100 of this embodiment includes Step S11, Step S12, Step S13, and Step S14.

Step S11 is a step of forming the positive electrode composite material 210. Step S12 is a step of forming the electrolyte layer 220. Step S13 is a step of forming the negative electrode 30. Step S14 is a step of forming the current collectors 41 and 42.

### [6-2-1] Step S11

In the step of forming the positive electrode composite material 210 of Step S11, the positive electrode composite material 210 is formed.

The positive electrode composite material 210 can be formed, for example, as follows.

That is, first, for example, a slurry 210m as a mixture of the positive electrode active material 211 such as LiCoO₂, the solid composition according to the present disclosure, a binder such as polypropylene carbonate, and a solvent such as 1,4-dioxane is obtained. In the preparation of the slurry 210m, a dispersant, a diluent, a humectant, or the like may be further used as needed.

Subsequently, by using the slurry 210m, a positive electrode composite material forming sheet 210s is formed. More specifically, as shown in FIG. 14, for example, by using a fully automatic film applicator 500, the slurry 210m is applied to a predetermined thickness onto the base material 506 such as a polyethylene terephthalate film, whereby the positive electrode composite material forming sheet 210s is formed.

Thereafter, the solvent is removed from the positive electrode composite material forming sheet 210s formed on the base material 506, and the positive electrode composite material forming sheet 210s is detached from the base material 506 and punched to a predetermined size using a punching die as shown in FIG. 15, whereby a molded material 210f is formed.

Thereafter, the molded material 210f is subjected to a heating step at a temperature of 700° C. or higher and 1000° C. or lower, whereby the positive electrode composite material 210 including a solid electrolyte is obtained. The heating time and atmosphere in the heating step are as described above.

### [6-2-2] Step S12

After Step S11, the process proceeds to Step S12.

In the step of forming the electrolyte layer 220 of Step S12, the electrolyte layer 220 is formed at one face 210b of the positive electrode composite material 210. More specifically, for example, by using a sputtering device, sputtering is performed using LiCoO₂ as a target in an inert gas such as argon gas, whereby a LiCoO₂ layer is formed at a surface of the positive electrode composite material 210. Thereafter, the LiCoO₂ layer formed on the positive electrode composite material 210 is fired in an oxidizing atmosphere so as to convert the crystal of the LiCoO₂ layer into a high-temperature phase crystal, whereby the LiCoO₂ layer can be converted into the electrolyte layer 220. The firing conditions of the LiCoO₂ layer are not particularly limited, but the heating temperature can be set to 400° C. or higher and 600° C. or lower, and the heating time can be set to 1 hour or more and 3 hours or less.

### [6-2-3] Step S13

After Step S12, the process proceeds to Step S13.

In the step of forming the negative electrode 30 of Step S13, the negative electrode 30 is formed at an opposite face side of the electrolyte layer 220 from a face thereof facing the positive electrode composite material 210. More specifically, for example, by using a vacuum deposition device or the like, the negative electrode 30 can be formed by forming a thin film of metal Li at an opposite face side of the electrolyte layer 220 from a face thereof facing the positive electrode composite material 210.

### [6-2-4] Step S14

After Step S13, the process proceeds to Step S14.

In the step of forming the current collectors 41 and 42 of Step S14, the current collector 41 is formed so as to come in contact with the other face of the positive electrode composite material 210, that is, a face 210a at an opposite side from the face 210b at which the electrolyte layer 220 is formed, and the current collector 42 is formed so as to come in contact with the negative electrode 30.

The methods for forming the positive electrode composite material 210 and the electrolyte layer 220 are not limited to the above-mentioned methods. For example, the positive electrode composite material 210 and the electrolyte layer 220 may be formed as follows. That is, first, a slurry as a mixture of the solid composition according to the present disclosure, a binder, and a solvent is obtained. Then, the obtained slurry is fed to a fully automatic film applicator 500 and applied onto the base material 506, whereby an electrolyte forming sheet is formed. Thereafter, the electrolyte forming sheet and the positive electrode composite material forming sheet 210s formed in the same manner as described above are pressed in a stacked state and bonded to each other. Thereafter, a stacked sheet obtained by bonding the sheets is punched to form a molded material, and the molded material is fired in an oxidizing atmosphere, whereby a stacked body of the positive electrode composite material 210 and the electrolyte layer 220 may be obtained.

### [6-3] Method for Producing Secondary Battery of Third Embodiment

Next, a method for producing the secondary battery according to the third embodiment will be described.

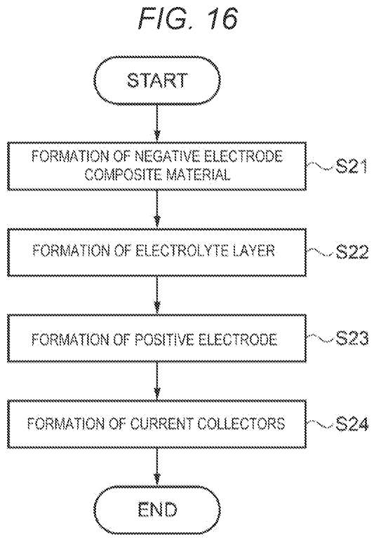

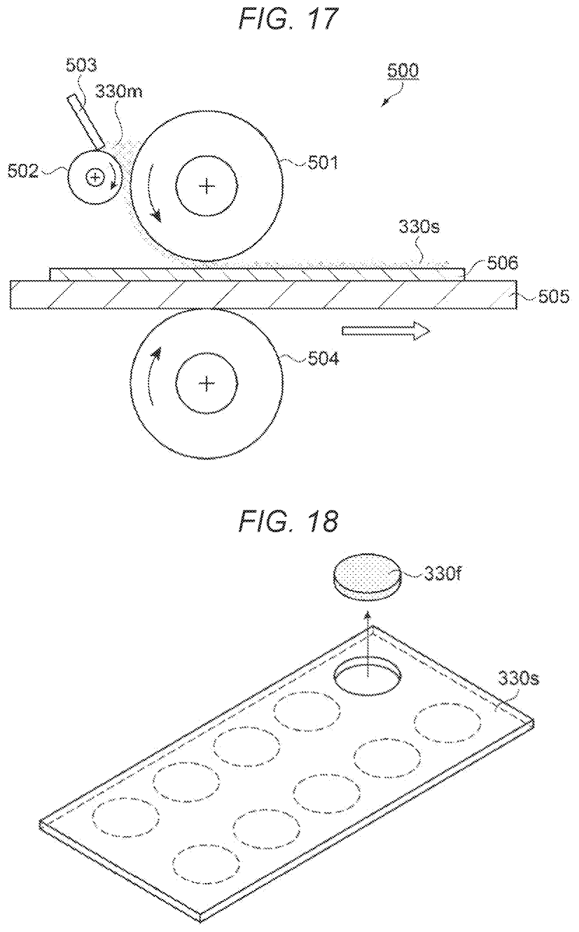

FIG. 16 is a flowchart showing the method for producing the lithium-ion battery as the secondary battery of the third embodiment, and FIGS. 17 and 18 are schematic views schematically showing the method for producing the lithium-ion battery as the secondary battery of the third embodiment.

Hereinafter, the method for producing the secondary battery according to the third embodiment will be described with reference to these drawings, but different points from the above-mentioned embodiments will be mainly described, and the description of the same matter will be omitted.

As shown in FIG. 16, the method for producing the lithium-ion battery 100 of this embodiment includes Step S21, Step S22, Step S23, and Step S24.

Step S21 is a step of forming the negative electrode composite material 330. Step S22 is a step of forming the electrolyte layer 220. Step S23 is a step of forming the positive electrode 10. Step S24 is a step of forming the current collectors 41 and 42.

### [6-3-1] Step S21

In the step of forming the negative electrode composite material 330 of Step S21, the negative electrode composite material 330 is formed.

The negative electrode composite material 330 can be formed, for example, as follows.

That is, first, for example, a slurry 330m as a mixture of the negative electrode active material 331 such as Li₄Ti₅O₁₂, the solid composition according to the present disclosure, a binder such as polypropylene carbonate, and a solvent such as 1,4-dioxane is obtained. In the preparation of the slurry 330m, a dispersant, a diluent, a humectant, or the like may be further used as needed.

Subsequently, by using the slurry 330m, a negative electrode composite material forming sheet 330s is formed. More specifically, as shown in FIG. 17, for example, by using a fully automatic film applicator 500, the slurry 330m is applied to a predetermined thickness onto the base material 506 such as a polyethylene terephthalate film, whereby the negative electrode composite material forming sheet 330s is formed.

Thereafter, the solvent is removed from the negative electrode composite material forming sheet 330s formed on the base material 506, and the negative electrode composite material forming sheet 330s is detached from the base material 506 and punched to a predetermined size using a punching die as shown in FIG. 18, whereby a molded material 330f is formed.

Thereafter, the molded material 330f is subjected to a heating step at a temperature of 700° C. or higher and 1000° C. or lower, whereby the negative electrode composite material 330 including a solid electrolyte is obtained. The heating time and atmosphere in the heating step are as described above.

### [6-3-2] Step S22

After Step S21, the process proceeds to Step S22.

In the step of forming the electrolyte layer 220 of Step S22, the electrolyte layer 220 is formed at one face 330a of the negative electrode composite material 330. More specifically, for example, by using a sputtering device, sputtering is performed using Li_{2.2}C_{0.8}B_{0.2}O₃ which is a solid solution of Li₂CO₃ and Li₃BO₃ as a target in an inert gas such as argon gas, whereby a Li_{2.2}C_{0.8}B_{0.2}O₃ layer is formed at a surface of the negative electrode composite material 330. Thereafter, the Li_{2.2}C_{0.8}B_{0.2}O₃ layer formed on the negative electrode composite material 330 is fired in an oxidizing atmosphere so as to convert the crystal of the Li_{2.2}C_{0.8}B_{0.2}O₃ layer into a high-temperature phase crystal, whereby the Li_{2.2}C_{0.8}B_{0.2}O₃ layer can be converted into the electrolyte layer 220. The firing conditions of the Li_{2.2}C_{0.8}B_{0.2}O₃ layer are not particularly limited, but the heating temperature can be set to 400° C. or higher and 600° C. or lower, and the heating time can be set to 1 hour or more and 3 hours or less.

### [6-3-3] Step S23

After Step S22, the process proceeds to Step S23.

In the step of forming the positive electrode 10 of Step S23, the positive electrode 10 is formed at one face 220a side of the electrolyte layer 220, that is, an opposite face side of the electrolyte layer 220 from a face thereof facing the negative electrode composite material 330. More specifically, for example, first, by using a vacuum deposition device or the like, a LiCoO₂ layer is formed at one face 220a of the electrolyte layer 220. Thereafter, a stacked body of the electrolyte layer 220 at which the LiCoO₂ layer is formed, and the negative electrode composite material 330 is fired so as to convert the crystal of the LiCoO₂ layer into a high-temperature phase crystal, whereby the LiCoO₂ layer can be converted into the positive electrode 10. The firing conditions of the LiCoO₂ layer are not particularly limited, but the heating temperature can be set to 400° C. or higher and 600° C. or lower, and the heating time can be set to 1 hour or more and 3 hours or less.

### [6-3-4] Step S24

After Step S23, the process proceeds to Step S24.

In the step of forming the current collectors 41 and 42 of Step S24, the current collector 41 is formed so as to come in contact with one face 10a of the positive electrode 10, that is, the face 10a of the positive electrode 10 at an opposite side from the face at which the electrolyte layer 220 is formed, and the current collector 42 is formed so as to come in contact with the other face of the negative electrode composite material 330, that is, a face 330b of the negative electrode composite material 330 at an opposite side from the face 330a at which the electrolyte layer 220 is formed.

The methods for forming the negative electrode composite material 330 and the electrolyte layer 220 are not limited to the above-mentioned methods. For example, the negative electrode composite material 330 and the electrolyte layer 220 may be formed as follows. That is, first, a slurry as a mixture of the solid composition according to the present disclosure, a binder, and a solvent is obtained. Then, the obtained slurry is fed to a fully automatic film applicator 500 and applied onto the base material 506, whereby an electrolyte forming sheet is formed. Thereafter, the electrolyte forming sheet and the negative electrode composite material forming sheet 330s formed in the same manner as described above are pressed in a stacked state and bonded to each other. Thereafter, a stacked sheet obtained by bonding the sheets is punched to form a molded material, and the molded material is fired in an oxidizing atmosphere, whereby a stacked body of the negative electrode composite material 330 and the electrolyte layer 220 may be obtained.

### [6-4] Method for Producing Secondary Battery of Fourth Embodiment

Next, a method for producing the secondary battery according to the fourth embodiment will be described.

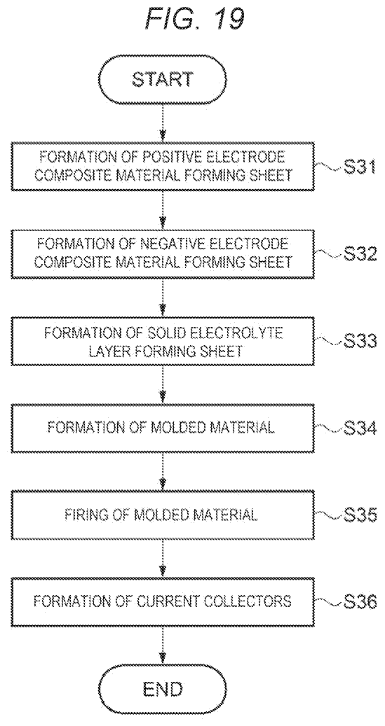

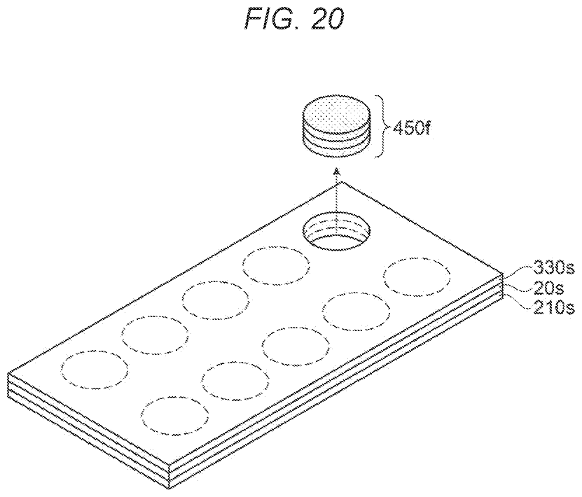

FIG. 19 is a flowchart showing the method for producing the lithium-ion battery as the secondary battery of the fourth embodiment, and FIG. 20 is a schematic view schematically showing the method for producing the lithium-ion battery as the secondary battery of the fourth embodiment.

Hereinafter, the method for producing the secondary battery according to the fourth embodiment will be described with reference to these drawings, but different points from the above-mentioned embodiments will be mainly described, and the description of the same matter will be omitted.

As shown in FIG. 19, the method for producing the lithium-ion battery 100 of this embodiment includes Step S31, Step S32, Step S33, Step S34, Step S35, and Step S36.

Step S31 is a step of forming a sheet for forming the positive electrode composite material 210. Step S32 is a step of forming a sheet for forming the negative electrode composite material 330. Step S33 is a step of forming a sheet for forming the solid electrolyte layer 20. Step S34 is a step of forming a molded material 450f of molding a stacked body of the sheet for forming the positive electrode composite material 210, the sheet for forming the negative electrode composite material 330, and the sheet for forming the solid electrolyte layer 20 into a predetermined shape. Step S35 is a step of firing the molded material 450f. Step S36 is a step of forming the current collectors 41 and 42.

In the following description, a description will be made by assuming that Step S32 is performed after Step S31, and Step S33 is performed after Step S32, however, the order of Step S31, Step S32, and Step S33 is not limited thereto, and the order of the steps may be changed, or the steps may be concurrently performed.

### [6-4-1] Step S31

In the step of forming a sheet for forming the positive electrode composite material 210 of Step S31, a positive electrode composite material forming sheet 210s that is the sheet for forming the positive electrode composite material 210 is formed.

The positive electrode composite material forming sheet 210s can be formed, for example, in the same manner as described in the above second embodiment.

The positive electrode composite material forming sheet 210s obtained in this step is preferably one obtained by removing the solvent from the slurry 210m used for forming the positive electrode composite material forming sheet 210s.

### [6-4-2] Step S32

After Step S31, the process proceeds to Step S32.

In the step of forming a sheet for forming the negative electrode composite material 330 of Step S32, a negative electrode composite material forming sheet 330s that is the sheet for forming the negative electrode composite material 330 is formed.

The negative electrode composite material forming sheet 330s can be formed, for example, in the same manner as described in the above third embodiment.

The negative electrode composite material forming sheet 330s obtained in this step is preferably one obtained by removing the solvent from the slurry 330m used for forming the negative electrode composite material forming sheet 330s.

### [6-4-3] Step S33

After Step S32, the process proceeds to Step S33.

In the step of forming a sheet for forming the solid electrolyte layer 20 of Step S33, a solid electrolyte layer forming sheet 20s that is the sheet for forming the solid electrolyte layer 20 is formed.

The solid electrolyte layer forming sheet 20s can be formed, for example, in the same manner as described in the above first embodiment.

The solid electrolyte layer forming sheet 20s obtained in this step is preferably one obtained by removing the solvent from the slurry 20m used for forming the solid electrolyte layer forming sheet 20s.

### [6-4-4] Step S34

After Step S33, the process proceeds to Step S34.

In the step of forming the molded material 450f of Step S34, the positive electrode composite material forming sheet 210s, the solid electrolyte layer forming sheet 20s, and the negative electrode composite material forming sheet 330s are pressed in a state of being stacked in this order and bonded to one another. Thereafter, as shown in FIG. 20, a stacked sheet obtained by bonding the sheets is punched, whereby the molded material 450f is obtained.

### [6-4-5] Step S35

After Step S34, the process proceeds to Step S35.

In the step of firing the molded material 450f of Step S35, the molded material 450f is subjected to a heating step at a temperature of 700° C. or higher and 1000° C. or lower. By doing this, a portion constituted by the positive electrode composite material forming sheet 210s is converted into the positive electrode composite material 210, a portion constituted by the solid electrolyte layer forming sheet 20s is converted into the solid electrolyte layer 20, and a portion constituted by the negative electrode composite material forming sheet 330s is converted into the negative electrode composite material 330. That is, a fired body of the molded material 450f is a stacked body of the positive electrode composite material 210, the solid electrolyte layer 20, and the negative electrode composite material 330. The heating time and atmosphere in the heating step are as described above.

### [6-4-6] Step S36

After Step S35, the process proceeds to Step S36.

In the step of forming the current collectors 41 and 42 of Step S36, the current collector 41 is formed so as to come in contact with the face 210a of the positive electrode composite material 210, and the current collector 42 is formed so as to come in contact with the face 330b of the negative electrode composite material 330.

Hereinabove, preferred embodiments of the present disclosure have been described, however, the present disclosure is not limited thereto.

For example, the method for producing a solid composition according to the present disclosure may be applied to a method further including another step in addition to the steps as described above. More specifically, for example, in addition to the above-mentioned steps, the method may include a step of mixing a lithium compound other than a lithium oxoacid salt, that is, a lithium compound that is not an oxoacid compound with a composition containing at least a precursor oxide. Further, the method may include, for example, a drying step of removing a liquid component contained in the system after the precursor oxide production step.

Further, the method for producing a functional ceramic molded body according to the present disclosure may be applied to a method further including another step in addition to the steps as described above.

Further, when the present disclosure is applied to a secondary battery, the configuration of the secondary battery is not limited to those of the above-mentioned embodiments.

For example, when the present disclosure is applied to a secondary battery, the secondary battery is not limited to a lithium-ion battery, and may be, for example, a secondary battery in which a porous separator is provided between a positive electrode composite material and a negative electrode, and the separator is impregnated with an electrolyte solution.

Further, when the present disclosure is applied to a secondary battery, the production method therefor is not limited to those of the above-mentioned embodiments. For example, the order of the steps in the production of the secondary battery may be made different from that in the above-mentioned embodiments.

Further, in the above-mentioned embodiments, the solid electrolyte according to the present disclosure has been described as one constituting a part of a secondary battery, particularly, a part of an all-solid-state lithium secondary battery that is an all-solid-state secondary battery, however, the solid electrolyte according to the present disclosure may constitute, for example, a part other than an all-solid-state secondary battery or may constitute a part other than a secondary battery.

Hereinabove, preferred embodiments of the present disclosure have been described, however, the present disclosure is not limited thereto.

For example, the method for producing a solid composition according to the present disclosure may be applied to a method further including another step in addition to the steps as described above. More specifically, for example, the method may include a drying step of removing a liquid component contained in the system after the precursor oxide production step.

Further, the method for producing a functional ceramic molded body according to the present disclosure may be applied to a method further including another step in addition to the steps as described above.

Further, in the above-mentioned embodiments, a case where the solid composition according to the present disclosure contains the precursor oxide, the oxoacid compound, and the second functional ceramic as different particles, that is, as the first particles, the second particles, and the third particles, respectively, has been described, however, the solid composition according to the present disclosure may include, as the constituent particles, those containing two or more types of the precursor oxide, the oxoacid compound, and the second functional ceramic in a single particle by aggregation or the like.

### EXAMPLES

Next, specific Examples of the present disclosure will be described.

### [7] Production of First Particles, Second Particles, and Third Particles

First, first particles constituted by a precursor oxide, second particles constituted by a second functional ceramic, and third particles constituted by an oxoacid compound were produced.

### [7-1] Production of First Particles

### Production Example A1

First, yttrium triethoxide as an yttrium source, aluminum triisopropoxide as an aluminum source, cerium triisopropoxide as a cerium source, and 2-n-butoxyethanol as a solvent were mixed at ratios shown in Table 1, respectively, whereby a mixture was obtained. This mixture and 2-n-butoxyethanol as a solvent were mixed at a predetermined ratio, whereby a metal compound solution as a mixed solution in which the respective raw material compounds were dissolved was obtained.

Subsequently, the thus obtained metal compound solution as the mixed solution was subjected to a first heat treatment in the air at 140° C. for 20 minutes in a state of being placed in a beaker made of titanium, whereby a mixture in a gel form was obtained.

Subsequently, the thus obtained mixture in a gel form was subjected to a second heat treatment in the air at 540° C. for 20 minutes, whereby a precursor oxide that is a thermally decomposed product in an ash form was obtained.

Subsequently, the precursor oxide was ground using an agate mortar, and further subjected to classification, whereby particles having an average particle diameter of 3 μm were obtained, which were used as first particles.

### Production Examples A2 and A3

First particles were produced in the same manner as in the above Production Example A1 except that the formulation of the mixed liquid is as shown in Table 1 by adjusting the types and used amounts of raw materials used in the preparation of the mixed liquid.

### Production Example A4

First particles were produced in the same manner as in the above Production Example A1 except that the average particle diameter of the particles was adjusted to 10 μm.

### Production Example A5

First particles were produced in the same manner as in the above Production Example A2 except that the average particle diameter of the particles was adjusted to 10 μm.

### Production Example A6

First particles were produced in the same manner as in the above Production Example A3 except that the average particle diameter of the particles was adjusted to 10 μm.

### Production Example A7

First, lanthanum triisopropoxide as a lanthanum source, zirconium tetra-n-butoxide as a zirconium source, antimony tri-n-butoxide as an antimony source, and tantalum pentaethoxide as a tantalum source were mixed at ratios shown in Table 2, respectively, whereby a mixture was obtained. This mixture and 2-n-butoxyethanol as a solvent were mixed at a predetermined ratio, whereby a metal compound solution as a mixed solution in which the respective raw material compounds were dissolved was obtained.

The thus obtained metal compound solution as the mixed solution was subjected to a first heat treatment in the air at 140° C. for 20 minutes in a state of being placed in a beaker made of titanium, whereby a composition in a gel form was obtained.

Subsequently, the thus obtained composition in a gel form was subjected to a second heat treatment in the air at 540° C. for 20 minutes, whereby a precursor oxide that is a thermally decomposed product in an ash form was obtained.

Subsequently, the precursor oxide was ground using an agate mortar, and further subjected to classification, whereby particles having an average particle diameter of 3 μm were obtained, which were used as first particles.

### Production Example A8

First, lanthanum triisopropoxide as a lanthanum source, zirconium tetra-n-butoxide as a zirconium source, and niobium pentaethoxide as a niobium source were mixed at ratios shown in Table 2, respectively, whereby a mixture was obtained. This mixture and 2-n-butoxyethanol as a solvent were mixed at a predetermined ratio, whereby a metal compound solution as a mixed solution in which the respective raw material compounds were dissolved was obtained.

The thus obtained metal compound solution as the mixed solution was subjected to a first heat treatment in the air at 140° C. for 20 minutes in a state of being placed in a beaker made of titanium, whereby a composition in a gel form was obtained.

Subsequently, the thus obtained composition in a gel form was subjected to a second heat treatment in the air at 540° C. for 20 minutes, whereby a precursor oxide that is a thermally decomposed product in an ash form was obtained.

Subsequently, the precursor oxide was ground using an agate mortar, and further subjected to classification, whereby particles having an average particle diameter of 3 μm were obtained, which were used as first particles.

### Production Example A9

First, lanthanum triisopropoxide as a lanthanum source, zirconium tetra-n-butoxide as a zirconium source, and tantalum pentaethoxide as a tantalum source were mixed at ratios shown in Table 2, respectively, whereby a mixture was obtained. This mixture and 2-n-butoxyethanol as a solvent were mixed at a predetermined ratio, whereby a metal compound solution as a mixed solution in which the respective raw material compounds were dissolved was obtained.

Subsequently, the thus obtained metal compound solution as the mixed solution was subjected to a first heat treatment in the air at 140° C. for 20 minutes in a state of being placed in a beaker made of titanium, whereby a composition in a gel form was obtained.

Subsequently, the thus obtained composition in a gel form was subjected to a second heat treatment in the air at 540° C. for 20 minutes, whereby a precursor oxide that is a thermally decomposed product in an ash form was obtained.

Subsequently, the precursor oxide was ground using an agate mortar, and further subjected to classification, whereby particles having an average particle diameter of 3 μm were obtained, which were used as first particles.

With respect to samples of the first particles of the above Production Examples A1 to A9, the elemental distribution and formulation were examined by various analytical methods, and from the transmission electron microscopic observation using JEM-ARM200F manufactured by JEOL Ltd. and the results of selected area electron diffraction, it was confirmed that the samples of the above Production Examples A1 to A9 are constituted by an amorphous region having a relatively large size of about several hundred nanometers or more, and a region of an assembly composed of nanocrystals with a size of 30 nm or less.

With respect to the above Production Examples A1 to A9, the formulations and ratios of the raw materials used for producing the first particles, the conditions of the first heat treatment and the second heat treatment, and the average particle diameter of the first particles are collectively shown in Tables 1 and 2. Note that in all the first particles obtained in the above Production Examples A1 to A9, the content of the solvent was 0.1 mass % or less. Further, when measurement was performed by TG-DTA at a temperature raising rate of 10° C./min for some of the first particles of the above Production Examples A1 to A9, only one exothermic peak was observed in a range of 300° C. or higher and 1,000° C. or lower in all the cases. From the results, it can be said that the precursor oxides constituting the first particles of the above Production Examples A1 to A9 are constituted by a substantially single crystal phase.

TABLE 1

| | | | | | | | | | Average |
|---|---|---|---|---|---|---|---|---|---|
| | | | | | First heat | | | | particle |
| | Raw material compound | | Solvent | | treatment | Second heat treatment | | | diameter |
| | | Used amount | | Used amount | Heating | Heating | Heating | | of first |
| | | [parts | | [parts | temperature | temperature | time | Atmo- | particles |
| | Type | by mass] | Type | by mass] | [° C.] | [° C.] | [min] | sphere | [μm] |
| Production | cerium triisopropoxide | 0.29 | 2-n-butoxy- | 153 | 140 | 540 | 20 | air | 3 |
| Example A1 | aluminum triisopropoxide | 10.20 | ethanol | | | | | | |
| | yttrium triethoxide | 6.52 | | | | | | | |
| Production | yttrium triethoxide | 2.24 | 2-n-butoxy- | 177 | 140 | 540 | 20 | air | 3 |
| Example A2 | barium diethoxide | 4.55 | ethanol | | | | | | |
| | bis(dipivaloylmethanato)copper | 12.9 | | | | | | | |
| Production | yttrium triethoxide | 6.72 | 2-n-butoxy- | 211 | 140 | 540 | 20 | air | 3 |
| Example A3 | aluminum tripropoxide | 1.22 | ethanol | | | | | | |
| | tris(2,4-pentanedionato)iron | 15.5 | | | | | | | |
| Production | cerium triisopropoxide | 0.29 | 2-n-butoxy- | 153 | 140 | 540 | 20 | air | 10 |
| Example A4 | aluminum tripropoxide | 10.20 | ethanol | | | | | | |
| | yttrium triethoxide | 6.52 | | | | | | | |
| Production | yttrium triethoxide | 2.24 | 2-n-butoxy- | 177 | 140 | 540 | 20 | air | 10 |
| Example A5 | barium diethoxide | 4.55 | ethanol | | | | | | |
| | bis(dipivaloylmethanato)copper | 12.9 | | | | | | | |
| Production | yttrium triethoxide | 6.72 | 2-n-butoxy- | 211 | 140 | 540 | 20 | air | 10 |
| Example A6 | aluminum tripropoxide | 1.22 | ethanol | | | | | | |
| | tris(2,4-pentanedionato)iron | 15.5 | | | | | | | |

TABLE 2

| | | | | | | | | | Average |
|---|---|---|---|---|---|---|---|---|---|
| | | | | | First heat | | | | particle |
| | Raw material compound | | Solvent | | treatment | Second heat treatment | | | diameter |
| | | Used amount | | Used amount | Heating | Heating | Heating | | of first |
| | | [parts | | [parts | temperature | temperature | time | Atmo- | particles |
| | Type | by mass] | Type | by mass] | [° C.] | [° C.] | [min] | sphere | [μm] |
| Production | zirconium tetra-n-butoxide | 4.60 | 2-n-butoxy- | 149 | 140 | 540 | 20 | air | 3 |
| Example A7 | antimony tri-n-butoxide | 1.71 | ethanol | | | | | | |
| | tantalum pentaethoxide | 0.81 | | | | | | | |
| | lanthanum triisopropoxide | 9.48 | | | | | | | |
| Production | zirconium tetra-n-butoxide | 6.71 | 2-n-butoxy- | 153 | 140 | 540 | 20 | air | 3 |
| Example A8 | niobium pentaethoxide | 0.80 | ethanol | | | | | | |
| | lanthanum triisopropoxide | 9.48 | | | | | | | |
| Production | zirconium tetra-n-butoxide | 6.71 | 2-n-butoxy- | 155 | 140 | 540 | 20 | air | 3 |
| Example A9 | tantalum pentaethoxide | 1.02 | ethanol | | | | | | |
| | lanthanum triisopropoxide | 9.48 | | | | | | | |

### [7-2] Production of Second Particles

### Production Example B1

A mixed powder was obtained by weighing 3.29 parts by mass of a Y₂O₃ powder, 0.155 parts by mass of a CeO₂ powder, and 2.55 parts by mass of an Al₂O₃ powder, and sufficiently mixing these powders while grinding using an agate mortar.

Subsequently, 1 g of the resulting mixture was filled in a pellet die with an exhaust port having an inner diameter of 13 mm manufactured by Specac, Inc., followed by press molding with a load of 6 kN, whereby a pellet as a molded material was obtained. The obtained pellet was placed in a crucible made of alumina and sintered in an air atmosphere at 1200° C. for 8 hours, whereby a pellet of a second functional ceramic that is a solid electrolyte was obtained.

Thereafter, the pellet of the second functional ceramic was ground using an agate mortar, and further subjected to classification, whereby particles having an average particle diameter of 50 μm were obtained, which were used as second particles.

### Production Example B2

Second particles were produced in the same manner as in the above Production Example B1 except that the average particle diameter of the particles was adjusted to 20 μm.

### Production Example B3

Second particles were produced in the same manner as in the above Production Example B1 except that the average particle diameter of the particles was adjusted to 10 μm.

### Production Example B4

Second particles were produced in the same manner as in the above Production Example B1 except that the average particle diameter of the particles was adjusted to 5 μm.

### Production Example B5

Second particles were produced in the same manner as in the above Production Example B1 except that the average particle diameter of the particles was adjusted to 3 μm.

### Production Example B6

Second particles were produced in the same manner as in the above Production Example B1 except that the average particle diameter of the particles was adjusted to 1 μm.

### Production Example B7

A mixed powder was obtained by weighing 1.13 parts by mass of a Y₂O₃ powder, 3.07 parts by mass of a BaO powder, and 2.39 parts by mass of a CuO powder, and sufficiently mixing these powders while grinding using an agate mortar.

Subsequently, 1 g of the resulting mixture was filled in a pellet die with an exhaust port having an inner diameter of 13 mm manufactured by Specac, Inc., followed by press molding with a load of 6 kN, whereby a pellet as a molded material was obtained. The obtained pellet was placed in a crucible made of alumina and sintered in an air atmosphere at 950° C. for 8 hours, whereby a pellet of a second functional ceramic that is a solid electrolyte was obtained.

Thereafter, the pellet of the second functional ceramic was ground using an agate mortar, and further subjected to classification, whereby particles having an average particle diameter of 50 μm were obtained, which were used as second particles.

### Production Example B8

Second particles were produced in the same manner as in the above Production Example B7 except that the average particle diameter of the particles was adjusted to 20 μm.

### Production Example B9

Second particles were produced in the same manner as in the above Production Example B7 except that the average particle diameter of the particles was adjusted to 10 μm.

### Production Example B10

Second particles were produced in the same manner as in the above Production Example B7 except that the average particle diameter of the particles was adjusted to 5 μm.

### Production Example B11

Second particles were produced in the same manner as in the above Production Example B7 except that the average particle diameter of the particles was adjusted to 3 μm.

### Production Example B12

Second particles were produced in the same manner as in the above Production Example B7 except that the average particle diameter of the particles was adjusted to 1 μm.

### Production Example B13

A mixed powder was obtained by weighing 3.39 parts by mass of a Y₂O₃ powder, 0.31 parts by mass of an Al₂O₃ powder, and 3.51 parts by mass of an Fe₂O₃ powder, and sufficiently mixing these powders while grinding using an agate mortar.

Subsequently, 1 g of the resulting mixture was filled in a pellet die with an exhaust port having an inner diameter of 13 mm manufactured by Specac, Inc., followed by press molding with a load of 6 kN, whereby a pellet as a molded material was obtained. The obtained pellet was placed in a crucible made of alumina and sintered in an air atmosphere at 1400° C. for 8 hours, whereby a pellet of a second functional ceramic that is a solid electrolyte was obtained.

Thereafter, the pellet of the second functional ceramic was ground using an agate mortar, and further subjected to classification, whereby particles having an average particle diameter of 50 μm were obtained, which were used as second particles.

### Production Example B14

Second particles were produced in the same manner as in the above Production Example B13 except that the average particle diameter of the particles was adjusted to 20 μm.

### Production Example B15

Second particles were produced in the same manner as in the above Production Example B13 except that the average particle diameter of the particles was adjusted to 10 μm.

### Production Example B16

Second particles were produced in the same manner as in the above Production Example B13 except that the average particle diameter of the particles was adjusted to 5 μm.

### Production Example B17

Second particles were produced in the same manner as in the above Production Example B13 except that the average particle diameter of the particles was adjusted to 3 μm.

### Production Example B18

Second particles were produced in the same manner as in the above Production Example B13 except that the average particle diameter of the particles was adjusted to Production Example B19

First, 2.59 parts by mass of a Li₂CO₃ powder as a lithium source, 4.89 parts by mass of a La₂O₃ powder as a lanthanum source, and 2.46 parts by mass of a ZrO₂ powder as a zirconium source were prepared, and these powders were ground and mixed using an agate mortar, whereby a mixture was obtained.

Subsequently, 1 g of the resulting mixture was filled in a pellet die with an exhaust port having an inner diameter of 13 mm manufactured by Specac, Inc., followed by press molding with a load of 6 kN, whereby a pellet as a molded material was obtained. The obtained pellet was placed in a crucible made of alumina and sintered in an air atmosphere at 1250° C. for 8 hours, whereby a solid electrolyte pellet constituted by Li₇La₃Zr₂O₁₂ was obtained.

Subsequently, the solid electrolyte pellet was ground using an agate mortar, and further subjected to classification, whereby particles having an average particle diameter of 20 μm were obtained, which were used as second particles.

### Production Example B20

Li₇La₃Zr₂O₁₂ particles were obtained in the same manner as in the above Production Example B19 except that the average particle diameter of the Li₇La₃Zr₂O₁₂ particles was adjusted to 10 μm, which were used as second particles.

### Production Example B21

Li₇La₃Zr₂O₁₂ particles were obtained in the same manner as in the above Production Example B19 except that the average particle diameter of the Li₇La₃Zr₂O₁₂ particles was adjusted to 5 μm, which were used as second particles.

### Production Example B22

Li₇La₃Zr₂O₁₂ particles were obtained in the same manner as in the above Production Example B19 except that the average particle diameter of the Li₇La₃Zr₂O₁₂ particles was adjusted to 3 μm, which were used as second particles.

### Production Example B23

Li₇La₃Zr₂O₁₂ particles were obtained in the same manner as in the above Production Example B19 except that the average particle diameter of the Li₇La₃Zr₂O₁₂ particles was adjusted to 1 μm, which were used as second particles.

### Production Example B24

First, a first solution containing lanthanum nitrate hexahydrate as a lanthanum source, zirconium tetra-n-butoxide as a zirconium source, antimony tri-n-butoxide as an antimony source, tantalum pentaethoxide as a tantalum source, and 2-n-butoxyethanol as a solvent at a predetermined ratio was prepared, and a second solution containing lithium nitrate as a lithium compound and 2-n-butoxyethanol as a solvent at a predetermined ratio was prepared.

Subsequently, the first solution and the second solution were mixed at a predetermined ratio, whereby a mixed liquid in which the content ratio of Li, La, Zr, Sb, and Ta was 6.3:3:1.3:0.5:0.2 in molar ratio was obtained.

Subsequently, the thus obtained mixed liquid was subjected to a first heat treatment in the air at 140° C. for 20 minutes in a state of being placed in a beaker made of titanium, whereby a composition in a gel form was obtained.

Subsequently, the thus obtained mixture in a gel form was subjected to a second heat treatment in the air at 540° C. for 20 minutes, whereby a thermally decomposed product in an ash form was obtained.

1 g of the resulting thermally decomposed product in an ash form was filled in a pellet die with an exhaust port having an inner diameter of 13 mm manufactured by Specac, Inc., followed by press molding with a load of 6 kN, whereby a pellet as a molded material was obtained. The obtained pellet was placed in a crucible made of alumina and fired in an air atmosphere at 900° C. for 1 hour, whereby a solid electrolyte pellet constituted by Li_{6.3}La_{3.0}Zr_{1.3}Sb_{0.5}Ta_{0.2}O₁₂ was obtained.

Subsequently, the solid electrolyte pellet was ground using an agate mortar, and further subjected to classification, whereby particles having an average particle diameter of 20 μm were obtained, which were used as second particles. The content of the oxoacid compound in the thus obtained second particles was 10 ppm or less.

### Production Example B25

Li_{6.3}La_{3.0}Zr_{1.3}Sb_{0.5}Ta_{0.2}O₁₂ particles were obtained in the same manner as in the above Production Example B24 except that the average particle diameter of the Li_{6.3}La_{3.0}Zr_{1.3}Sb_{0.5}Ta_{0.2}O₁₂ particles was adjusted to 10 μm, which were used as second particles.

### Production Example B26

Li_{6.3}La_{3.0}Zr_{1.3}Sb_{0.5}Ta_{0.2}O₁₂ particles were obtained in the same manner as in the above Production Example B24 except that the average particle diameter of the Li_{6.3}La_{3.0}Zr_{1.3}Sb_{0.5}Ta_{0.2}O₁₂ particles was adjusted to 5 μm, which were used as second particles.

### Production Example B27

Li_{6.3}La_{3.0}Zr_{1.3}Sb_{0.5}Ta_{0.2}O₁₂ particles were obtained in the same manner as in the above Production Example B24 except that the average particle diameter of the Li_{6.3}La_{3.0}Zr_{1.3}Sb_{0.5}Ta_{0.2}O₁₂ particles was adjusted to 3 μm, which were used as second particles.

### Production Example B28

Li_{6.3}La_{3.0}Zr_{1.3}Sb_{0.5}Ta_{0.2}O₁₂ particles were obtained in the same manner as in the above Production Example B24 except that the average particle diameter of the Li_{6.3}La_{3.0}Zr_{1.3}Sb_{0.5}Ta_{0.2}O₁₂ particles was adjusted to 1 μm, which were used as second particles.

### [7-3] Production of Third Particles

### Production Example C1

Yttrium nitrate hexahydrate (manufactured by Kanto Chemical Co., Inc.) as an oxoacid compound was prepared.

Subsequently, this yttrium nitrate hexahydrate was ground using an agate mortar, and further subjected to classification, whereby particles having an average particle diameter of 2 μm were obtained, which were used as third particles.

### Production Example C2

Third particles were produced in the same manner as in the above Production Example C1 except that the average particle diameter of the particles was adjusted to 10 μm.

### Production Example C3

Yttrium sulfate octahydrate (manufactured by Wako Pure Chemical Corporation) as an oxoacid compound was prepared.

Subsequently, this yttrium sulfate octahydrate was ground using an agate mortar, and further subjected to classification, whereby particles having an average particle diameter of 2 μm were obtained, which were used as third particles.

### Production Example C4

Barium nitrate (manufactured by Wako Pure Chemical Corporation) as an oxoacid compound was prepared.

Subsequently, this barium nitrate was ground using an agate mortar, and further subjected to classification, whereby particles having an average particle diameter of 2 μm were obtained, which were used as third particles.

### Production Example C5

Third particles were produced in the same manner as in the above Production Example C4 except that the average particle diameter of the particles was adjusted to 5 μm.

### Production Example C6

Third particles were produced in the same manner as in the above Production Example C4 except that the average particle diameter of the particles was adjusted to 10 μm.

### Production Example C7

Iron(III) nitrate (manufactured by Kanto Chemical Co., Inc.) as an oxoacid compound was prepared.

Subsequently, this iron(III) nitrate was ground using an agate mortar, and further subjected to classification, whereby particles having an average particle diameter of 2 μm were obtained, which were used as third particles.

### Production Example C8

Third particles were produced in the same manner as in the above Production Example C7 except that the average particle diameter of the particles was adjusted to 10 μm.

### Production Example C9

Iron sulfate heptahydrate (manufactured by Kanto Chemical Co., Inc.) as an oxoacid compound was prepared.

Subsequently, this iron sulfate heptahydrate was ground using an agate mortar, and further subjected to classification, whereby particles having an average particle diameter of 2 μm were obtained, which were used as third particles.

### Production Example C10

Lithium nitrate (manufactured by Kanto Chemical Co., Inc.) as an oxoacid compound was prepared.

Subsequently, this lithium nitrate was ground using an agate mortar, and further subjected to classification, whereby particles having an average particle diameter of 2 μm were obtained, which were used as third particles.

### Production Example C11

Third particles were produced in the same manner as in the above Production Example C10 except that the average particle diameter of the particles was adjusted to Production Example C12

Third particles were produced in the same manner as in the above Production Example C10 except that the average particle diameter of the particles was adjusted to 10 μm.

### Production Example C13

Lithium sulfate monohydrate (manufactured by Kanto Chemical Co., Inc.) as an oxoacid compound was prepared.

Subsequently, this lithium sulfate monohydrate was ground using an agate mortar, and further subjected to classification, whereby particles having an average particle diameter of 2 μm were obtained, which were used as third particles.

### [8] Production of Solid Composition

### Example 1

50 parts by mass of the first particles obtained in the above Production Example A1, 47.5 parts by mass of the second particles obtained in the above Production Example B5, and 2.5 parts by mass of the third particles obtained in the above Production Example C1 were sufficiently mixed, whereby a solid composition was obtained.

### Examples 2 to 55

Solid compositions were produced in the same manner as in the above Example 1 except that the types of the first particles, the second particles, and the third particles, and the blending ratios thereof were changed as shown in Tables 3 to 6.

### Comparative Example 1

A powder constituted only by the second particles produced in Production Example B5 without using the first particles and the third particles was used as a solid composition of this Comparative Example.

### Comparative Example 2

A powder constituted only by the second particles produced in Production Example B11 without using the first particles and the third particles was used as a solid composition of this Comparative Example.

### Comparative Example 3

A powder constituted only by the second particles produced in Production Example B17 without using the first particles and the third particles was used as a solid composition of this Comparative Example.

### Comparative Example 4

A powder constituted only by the second particles produced in Production Example B26 without using the first particles and the third particles was used as a solid composition of this Comparative Example.

### Comparative Example 5

97.5 parts by mass of the first particles produced in Production Example A1 and 2.5 parts by mass of the third particles produced in Production Example C1 were sufficiently mixed without using the second particles, whereby a solid composition was obtained.

### Comparative Example 6

97.5 parts by mass of the first particles produced in Production Example A2 and 2.5 parts by mass of the third particles produced in Production Example C4 were sufficiently mixed without using the second particles, whereby a solid composition was obtained.

### Comparative Example 7

97.5 parts by mass of the first particles produced in Production Example A3 and 2.5 parts by mass of the third particles produced in Production Example C7 were sufficiently mixed without using the second particles, whereby a solid composition was obtained.

### Comparative Example 8

97.5 parts by mass of the first particles produced in Production Example A7 and 2.5 parts by mass of the third particles produced in Production Example C10 were sufficiently mixed without using the second particles, whereby a solid composition was obtained.

### Comparative Example 9

25 parts by mass of the first particles produced in Production Example A1 and 75 parts by mass of the second particles produced in Production Example B5 were sufficiently mixed without using the third particles, whereby a solid composition was obtained.

### Comparative Example 10

25 parts by mass of the first particles produced in Production Example A2 and 75 parts by mass of the second particles produced in Production Example B11 were sufficiently mixed without using the third particles, whereby a solid composition was obtained.

### Comparative Example 11

25 parts by mass of the first particles produced in Production Example A3 and 75 parts by mass of the second particles produced in Production Example B17 were sufficiently mixed without using the third particles, whereby a solid composition was obtained.

### Comparative Example 12

25 parts by mass of the first particles produced in Production Example A7 and 75 parts by mass of the second particles produced in Production Example B26 were sufficiently mixed without using the third particles, whereby a solid composition was obtained.

### Comparative Example 13

97.5 parts by mass of the second particles produced in Production Example B5 and 2.5 parts by mass of the third particles produced in Production Example C1 were sufficiently mixed without using the first particles, whereby a solid composition was obtained.

### Comparative Example 14

97.5 parts by mass of the second particles produced in Production Example B11 and 2.5 parts by mass of the third particles produced in Production Example C4 were sufficiently mixed without using the first particles, whereby a solid composition was obtained.

### Comparative Example 15

97.5 parts by mass of the second particles produced in Production Example B17 and 2.5 parts by mass of the third particles produced in Production Example C7 were sufficiently mixed without using the first particles, whereby a solid composition was obtained.

### Comparative Example 16

97.5 parts by mass of the second particles produced in Production Example B26 and 2.5 parts by mass of the third particles produced in Production Example C10 were sufficiently mixed without using the first particles, whereby a solid composition was obtained.

The configurations of the solid compositions of the respective Examples and the respective Comparative Examples are collectively shown in Tables 3 to 7. Further, in Tables 3 to 7, the value of XO/XP when the content of the oxoacid compound in the solid composition is represented by XO [mass %] and the content of the precursor oxide in the solid composition is represented by XP [mass %] is also shown. Note that in all the solid compositions obtained in the respective Examples and the respective Comparative Examples, the content of the solvent was 0.01 mass % or less. Further, the content of the liquid component in each of the solid compositions according to the respective Examples and the respective Comparative Examples was 100 ppm or less.

TABLE 3

| | First particles | | | | | Second particles | |
|---|---|---|---|---|---|---|---|
| | | | Crystal grain | Particle | | | Particle |
| | | | diameter | diameter D1 | Content XP | | diameter D2 |
| | Type | Crystal phase | [nm] | [μm] | [mass %] | Type | [μm] |
| Example 1 | A1 | perovskite | 40 | 3 | 50 | B5 | 3 |
| Example 2 | A1 | perovskite | 40 | 3 | 25 | B5 | 3 |
| Example 3 | A1 | perovskite | 40 | 3 | 12 | B5 | 3 |
| Example 4 | A1 | perovskite | 40 | 3 | 5 | B5 | 3 |
| Example 5 | A1 | perovskite | 40 | 3 | 25 | B6 | 1 |
| Example 6 | A1 | perovskite | 40 | 3 | 25 | B4 | 5 |
| Example 7 | A1 | perovskite | 40 | 3 | 25 | B3 | 10 |
| Example 8 | A1 | perovskite | 40 | 3 | 25 | B2 | 20 |
| Example 9 | A1 | perovskite | 40 | 3 | 25 | B1 | 50 |
| Example 10 | A4 | perovskite | 40 | 10 | 25 | B5 | 3 |
| Example 11 | A2 | copper oxide, BaCO₃, | 40 | 3 | 50 | B11 | 3 |
| | | yttrium carbonate | | | | | |
| Example 12 | A2 | copper oxide, BaCO₃, | 40 | 3 | 25 | B11 | 3 |
| | | yttrium carbonate | | | | | |
| Example 13 | A2 | copper oxide, BaCO₃, | 40 | 3 | 12 | B11 | 3 |
| | | yttrium carbonate | | | | | |
| Example 14 | A2 | copper oxide, BaCO₃, | 40 | 3 | 5 | B11 | 3 |
| | | yttrium carbonate | | | | | |
| Example 15 | A2 | copper oxide, BaCO₃, | 40 | 3 | 25 | B12 | 1 |
| | | yttrium carbonate | | | | | |
| Example 16 | A2 | copper oxide, BaCO₃, | 40 | 3 | 25 | B10 | 5 |
| | | yttrium carbonate | | | | | |

| | | Third particles | | | | |
|---|---|---|---|---|---|---|
| | Second particles | | | Particle | | |
| | Content X2 | | | diameter D3 | Content XO | |
| | [mass %] | Type | Formulation | [μm] | [mass %] | XO/XP |
| Example 1 | 47.5 | C1 | Y(NO₃)₃•6H₂O | 2 | 2.5 | 0.05 |
| Example 2 | 72.5 | C1 | Y(NO₃)₃•6H₂O | 2 | 2.5 | 0.1 |
| Example 3 | 85.5 | C1 | Y(NO₃)₃•6H₂O | 2 | 2.5 | 0.21 |
| Example 4 | 92.5 | C1 | Y(NO₃)₃•6H₂O | 2 | 2.5 | 0.5 |
| Example 5 | 72.5 | C1 | Y(NO₃)₃•6H₂O | 2 | 2.5 | 0.1 |
| Example 6 | 72.5 | C1 | Y(NO₃)₃•6H₂O | 2 | 2.5 | 0.1 |
| Example 7 | 72.5 | C1 | Y(NO₃)₃•6H₂O | 2 | 2.5 | 0.1 |
| Example 8 | 72.5 | C1 | Y(NO₃)₃•6H₂O | 2 | 2.5 | 0.1 |
| Example 9 | 72.5 | C1 | Y(NO₃)₃•6H₂O | 2 | 2.5 | 0.1 |
| Example 10 | 72.5 | C2/C3 | Y(NO₃)₃•6H₂O/ | 10/2 | 1.25/1.25 | 0.1 |
| | | | Y₂(SO₄)₃•8H₂O | | | |
| Example 11 | 47.5 | C4 | Ba(NO₃)₂ | 2 | 2.5 | 0.05 |
| Example 12 | 72.5 | C4 | Ba(NO₃)₂ | 2 | 2.5 | 0.1 |
| Example 13 | 85.5 | C4 | Ba(NO₃)₂ | 2 | 2.5 | 0.21 |
| Example 14 | 92.5 | C4 | Ba(NO₃)₂ | 2 | 2.5 | 0.5 |
| Example 15 | 72.5 | C4 | Ba(NO₃)₂ | 2 | 2.5 | 0.1 |
| Example 16 | 72.5 | C4 | Ba(NO₃)₂ | 2 | 2.5 | 0.1 |

TABLE 4

| | First particles | | | | | Second particles | |
|---|---|---|---|---|---|---|---|
| | | | Crystal grain | Particle | | | Particle |
| | | | diameter | diameter D1 | Content XP | | diameter D2 |
| | Type | Crystal phase | [nm] | [μm] | [mass %] | Type | [μm] |
| Example 17 | A2 | copper oxide, BaCO₃, | 40 | 3 | 25 | B9 | 10 |
| | | yttrium carbonate | | | | | |
| Example 18 | A2 | copper oxide, BaCO₃, | 40 | 3 | 25 | B8 | 20 |
| | | yttrium carbonate | | | | | |
| Example 19 | A2 | copper oxide, BaCO₃, | 40 | 3 | 25 | B7 | 50 |
| | | yttrium carbonate | | | | | |
| Example 20 | A5 | copper oxide, BaCO₃, | 40 | 10 | 25 | B11 | 3 |
| | | yttrium carbonate | | | | | |
| Example 21 | A3 | YFeO₃ | 40 | 3 | 50 | B17 | 3 |
| Example 22 | A3 | YFeO₃ | 40 | 3 | 25 | B17 | 3 |
| Example 23 | A3 | YFeO₃ | 40 | 3 | 12 | B17 | 3 |
| Example 24 | A3 | YFeO₃ | 40 | 3 | 5 | B17 | 3 |
| Example 25 | A3 | YFeO₃ | 40 | 3 | 25 | B18 | 1 |
| Example 26 | A3 | YFeO₃ | 40 | 3 | 25 | B16 | 5 |
| Example 27 | A3 | YFeO₃ | 40 | 3 | 25 | B15 | 10 |
| Example 28 | A3 | YFeO₃ | 40 | 3 | 25 | B14 | 20 |
| Example 29 | A3 | YFeO₃ | 40 | 3 | 25 | B13 | 50 |
| Example 30 | A6 | YFeO₃ | 40 | 10 | 25 | B17 | 3 |

| | | Third particles | | | | |
|---|---|---|---|---|---|---|
| | Second particles | | | Particle | | |
| | Content X2 | | | diameter D3 | Content XO | |
| | [mass %] | Type | Formulation | [μm] | [mass %] | XO/XP |
| Example 17 | 72.5 | C4 | Ba(NO₃)₂ | 2 | 2.5 | 0.1 |
| Example 18 | 72.5 | C4 | Ba(NO₃)₂ | 2 | 2.5 | 0.1 |
| Example 19 | 72.5 | C4 | Ba(NO₃)₂ | 2 | 2.5 | 0.1 |
| Example 20 | 72.5 | C5/C6 | Ba(NO₃)₂ | 5/10 | 1.25/1.25 | 0.1 |
| Example 21 | 47.5 | C7 | Fe(NO₃)₃ | 2 | 2.5 | 0.05 |
| Example 22 | 72.5 | C7 | Fe(NO₃)₃ | 2 | 2.5 | 0.1 |
| Example 23 | 85.5 | C7 | Fe(NO₃)₃ | 2 | 2.5 | 0.21 |
| Example 24 | 92.5 | C7 | Fe(NO₃)₃ | 2 | 2.5 | 0.5 |
| Example 25 | 72.5 | C7 | Fe(NO₃)₃ | 2 | 2.5 | 0.1 |
| Example 26 | 72.5 | C7 | Fe(NO₃)₃ | 2 | 2.5 | 0.1 |
| Example 27 | 72.5 | C7 | Fe(NO₃)₃ | 2 | 2.5 | 0.1 |
| Example 28 | 72.5 | C7 | Fe(NO₃)₃ | 2 | 2.5 | 0.1 |
| Example 29 | 72.5 | C7 | Fe(NO₃)₃ | 2 | 2.5 | 0.1 |
| Example 30 | 72.5 | C8/C9 | Fe(NO₃)₃/ | 10/2 | 1.25/1.25 | 0.1 |
| | | | FeSO₄•7H₂O | | | |

TABLE 5

| | First particles | | | | | Second particles | |
|---|---|---|---|---|---|---|---|
| | | | Crystal grain | Particle | | | Particle |
| | | | diameter | diameter D1 | Content XP | | diameter D2 |
| | Type | Crystal phase | [nm] | [μm] | [mass %] | Type | [μm] |
| Example 31 | A7 | pyrochlore | 30 | 3 | 50 | B21 | 5 |
| Example 32 | A7 | pyrochlore | 30 | 3 | 25 | B21 | 5 |
| Example 33 | A7 | pyrochlore | 30 | 3 | 12 | B21 | 5 |
| Example 34 | A7 | pyrochlore | 30 | 3 | 5 | B21 | 5 |
| Example 35 | A7 | pyrochlore | 30 | 3 | 25 | B23 | 1 |
| Example 36 | A7 | pyrochlore | 30 | 3 | 25 | B22 | 3 |
| Example 37 | A7 | pyrochlore | 30 | 3 | 25 | B20 | 10 |
| Example 38 | A7 | pyrochlore | 30 | 3 | 25 | B19 | 20 |
| Example 39 | A7 | pyrochlore | 30 | 3 | 25 | B21 | 5 |
| Example 40 | A7 | pyrochlore | 30 | 3 | 25 | B21 | 5 |
| Example 41 | A7 | pyrochlore | 30 | 3 | 25 | B21 | 5 |
| Example 42 | A8 | pyrochlore | 30 | 3 | 25 | B21 | 5 |
| Example 43 | A9 | pyrochlore | 30 | 3 | 25 | B21 | 5 |
| Example 44 | A7 | pyrochlore | 30 | 3 | 50 | B26 | 5 |
| Example 45 | A7 | pyrochlore | 30 | 3 | 25 | B26 | 5 |

| | | Third particles | | | | |
|---|---|---|---|---|---|---|
| | Second particles | | | Particle | | |
| | Content X2 | | | diameter D3 | Content XO | |
| | [mass %] | Type | Formulation | [μm] | [mass %] | XO/XP |
| Example 31 | 47.5 | C10 | LiNO₃ | 2 | 2.5 | 0.05 |
| Example 32 | 72.5 | C10 | LiNO₃ | 2 | 2.5 | 0.10 |
| Example 33 | 85.5 | C10 | LiNO₃ | 2 | 2.5 | 0.21 |
| Example 34 | 92.5 | C10 | LiNO₃ | 2 | 2.5 | 0.50 |
| Example 35 | 72.5 | C10 | LiNO₃ | 2 | 2.5 | 0.10 |
| Example 36 | 72.5 | C10 | LiNO₃ | 2 | 2.5 | 0.10 |
| Example 37 | 72.5 | C10 | LiNO₃ | 2 | 2.5 | 0.10 |
| Example 38 | 72.5 | C10 | LiNO₃ | 2 | 2.5 | 0.10 |
| Example 39 | 72.5 | C11 | LiNO₃ | 5 | 2.5 | 0.10 |
| Example 40 | 72.5 | C12 | LiNO₃ | 10 | 2.5 | 0.10 |
| Example 41 | 72.5 | C13 | Li₂SO₄•H₂O | 2 | 2.5 | 0.10 |
| Example 42 | 72.5 | C13 | Li₂SO₄•H₂O | 2 | 2.5 | 0.10 |
| Example 43 | 72.5 | C13 | Li₂SO₄•H₂O | 2 | 2.5 | 0.10 |
| Example 44 | 47.5 | C10 | LiNO₃ | 2 | 2.5 | 0.05 |
| Example 45 | 72.5 | C10 | LiNO₃ | 2 | 2.5 | 0.10 |

TABLE 6

| | First particles | | | | | Second particles | |
|---|---|---|---|---|---|---|---|
| | | | Crystal grain | Particle | | | Particle |
| | | | diameter | diameter D1 | Content XP | | diameter D2 |
| | Type | Crystal phase | [nm] | [μm] | [mass %] | Type | [μm] |
| Example 46 | A7 | pyrochlore | 30 | 3 | 12 | B26 | 5 |
| Example 47 | A7 | pyrochlore | 30 | 3 | 5 | B26 | 5 |
| Example 48 | A7 | pyrochlore | 30 | 3 | 25 | B28 | 1 |
| Example 49 | A7 | pyrochlore | 30 | 3 | 25 | B27 | 3 |
| Example 50 | A7 | pyrochlore | 30 | 3 | 25 | B25 | 10 |
| Example 51 | A7 | pyrochlore | 30 | 3 | 25 | B24 | 20 |
| Example 52 | A7 | pyrochlore | 30 | 3 | 25 | B26 | 5 |
| Example 53 | A7 | pyrochlore | 30 | 3 | 25 | B26 | 5 |
| Example 54 | A8 | pyrochlore | 30 | 3 | 25 | B26 | 5 |
| Example 55 | A9 | pyrochlore | 30 | 3 | 25 | B26 | 5 |

| | | Third particles | | | | |
|---|---|---|---|---|---|---|
| | Second particles | | | Particle | | |
| | Content X2 | | | diameter D3 | Content XO | |
| | [mass %] | Type | Formulation | [μm] | [mass %] | XO/XP |
| Example 46 | 85.5 | C10 | LiNO₃ | 2 | 2.5 | 0.21 |
| Example 47 | 92.5 | C10 | LiNO₃ | 2 | 2.5 | 0.50 |
| Example 48 | 72.5 | C10 | LiNO₃ | 2 | 2.5 | 0.10 |
| Example 49 | 72.5 | C10 | LiNO₃ | 2 | 2.5 | 0.10 |
| Example 50 | 72.5 | C10 | LiNO₃ | 2 | 2.5 | 0.10 |
| Example 51 | 72.5 | C10 | LiNO₃ | 2 | 2.5 | 0.10 |
| Example 52 | 72.5 | C11 | LiNO₃ | 5 | 2.5 | 0.10 |
| Example 53 | 72.5 | C12 | LiNO₃ | 10 | 2.5 | 0.10 |
| Example 54 | 72.5 | C13 | Li₂SO₄•H₂O | 2 | 2.5 | 0.10 |
| Example 55 | 72.5 | C13 | Li₂SO₄•H₂O | 2 | 2.5 | 0.10 |

TABLE 7

| | First particles | | | | | Second particles | |
|---|---|---|---|---|---|---|---|
| | | | Crystal grain | Particle | | | Particle |
| | | | diameter | diameter D1 | Content XP | | diameter D2 |
| | Type | Crystal phase | [nm] | [μm] | [mass %] | Type | [μm] |
| Comparative | — | — | — | — | — | B5 | 3 |
| Example 1 | | | | | | | |
| Comparative | — | — | — | — | — | B11 | 3 |
| Example 2 | | | | | | | |
| Comparative | — | — | — | — | — | B17 | 3 |
| Example 3 | | | | | | | |
| Comparative | — | — | — | — | — | B26 | 5 |
| Example 4 | | | | | | | |
| Comparative | A1 | perovskite | 40 | 3 | 97.5 | — | — |
| Example 5 | | | | | | | |
| Comparative | A2 | copper oxide, BaCO₃, | 40 | 3 | 97.5 | — | — |
| Example 6 | | yttrium carbonate | | | | | |
| Comparative | A3 | YFeO₃ | 40 | 3 | 97.5 | — | — |
| Example 7 | | | | | | | |
| Comparative | A7 | pyrochlore | 30 | 3 | 97.5 | — | — |
| Example 8 | | | | | | | |
| Comparative | A1 | perovskite | 40 | 3 | 25 | B5 | 3 |
| Example 9 | | | | | | | |
| Comparative | A2 | copper oxide, BaCO₃, | 40 | 3 | 25 | B11 | 3 |
| Example 10 | | yttrium carbonate | | | | | |
| Comparative | A3 | YFeO₃ | 40 | 3 | 25 | B17 | 3 |
| Example 11 | | | | | | | |
| Comparative | A7 | pyrochlore | 30 | 3 | 25 | B26 | 5 |
| Example 12 | | | | | | | |
| Comparative | — | — | — | — | — | B5 | 3 |
| Example 13 | | | | | | | |
| Comparative | — | — | — | — | — | B11 | 3 |
| Example 14 | | | | | | | |
| Comparative | — | — | — | — | — | B17 | 3 |
| Example 15 | | | | | | | |
| Comparative | — | — | — | — | — | B26 | 5 |
| Example 16 | | | | | | | |

| | | Third particles | | | | |
|---|---|---|---|---|---|---|
| | Second particles | | | Particle | | |
| | Content X2 | | | diameter D3 | Content XO | |
| | [mass %] | Type | Formulation | [μm] | [mass %] | XO/XP |
| Comparative | 100 | — | — | — | — | — |
| Example 1 | | | | | | |
| Comparative | 100 | — | — | — | — | — |
| Example 2 | | | | | | |
| Comparative | 100 | — | — | — | — | — |
| Example 3 | | | | | | |
| Comparative | 100 | — | — | — | — | — |
| Example 4 | | | | | | |
| Comparative | — | C1 | Y(NO₃)₃•6H₂O | 2 | 2.5 | 0.026 |
| Example 5 | | | | | | |
| Comparative | — | C4 | Ba(NO₃)₂ | 2 | 2.5 | 0.026 |
| Example 6 | | | | | | |
| Comparative | — | C7 | Fe(NO₃)₃ | 2 | 2.5 | 0.026 |
| Example 7 | | | | | | |
| Comparative | — | C10 | LiNO₃ | 2 | 2.5 | 0.026 |
| Example 8 | | | | | | |
| Comparative | 75 | — | — | — | — | 0 |
| Example 9 | | | | | | |
| Comparative | 75 | — | — | — | — | 0 |
| Example 10 | | | | | | |
| Comparative | 75 | — | — | — | — | 0 |
| Example 11 | | | | | | |
| Comparative | 75 | — | — | — | — | 0 |
| Example 12 | | | | | | |
| Comparative | 97.5 | C1 | Y(NO₃)₃•6H₂O | 2 | 2.5 | — |
| Example 13 | | | | | | |
| Comparative | 97.5 | C4 | Ba(NO₃)₂ | 2 | 2.5 | — |
| Example 14 | | | | | | |
| Comparative | 97.5 | C7 | Fe(NO₃)₃ | 2 | 2.5 | — |
| Example 15 | | | | | | |
| Comparative | 97.5 | C10 | LiNO₃ | 2 | 2.5 | — |
| Example 16 | | | | | | |

### [9] Production of Functional Ceramic Molded Body

By using the solid compositions of the respective Examples and the respective Comparative Examples, functional ceramic molded bodies were produced as follows.

First, 1 g of a sample was taken out from each of the solid compositions.

Subsequently, each sample thereof was filled in a pellet die with an exhaust port having an inner diameter of mm manufactured by Specac, Inc., followed by press molding with a load of 6 kN, whereby a pellet as a molded material was obtained. The obtained pellet was placed in a crucible made of alumina and fired in an air atmosphere at a predetermined temperature for 8 hours, whereby a functional ceramic molded body in a pellet form was obtained. For Examples 1 to 10 and Comparative Examples 1, 5, 9, and 13, the firing temperature was set to 900° C., for Examples 11 to 20 and Comparative Examples 2, 6, 10, and 14, the firing temperature was set to 800° C., for Examples 21 to 30 and Comparative Examples 3, 7, 11, and 15, the firing temperature was set to 900° C., and Examples 31 to 55 and Comparative Examples 4, 8, 12, and 16, the firing temperature was set to 900° C.

With respect to the solid compositions of the respective Examples and the respective Comparative Examples and the functional ceramic molded bodies obtained as described above using the solid compositions, an analysis was performed using an X-ray diffractometer X′Pert-PRO manufactured by Philips Electron Optics, Inc., whereby X-ray diffraction patterns were obtained.

As a result, it was confirmed that in the respective Examples, the precursor oxide contained in the solid composition and the first functional ceramic formed from the precursor oxide are constituted by mutually different crystal phases.

The formulations of the regions constituted by the first functional ceramics of the functional ceramic molded bodies according to the respective Examples and the respective Comparative Examples are collectively shown in Tables 8 to 10.

TABLE 8

| | Formulation | Crystal phase |
|---|---|---|
| Example 1 | Y_{2.91}Ce_{0.09}Al₅O₁₂ | cubic garnet-type |
| Example 2 | Y_{2.91}Ce_{0.09}Al₅O₁₂ | cubic garnet-type |
| Example 3 | Y_{2.91}Ce_{0.09}Al₅O₁₂ | cubic garnet-type |
| Example 4 | Y_{2.91}Ce_{0.09}Al₅O₁₂ | cubic garnet-type |
| Example 5 | Y_{2.91}Ce_{0.09}Al₅O₁₂ | cubic garnet-type |
| Example 6 | Y_{2.91}Ce_{0.09}Al₅O₁₂ | cubic garnet-type |
| Example 7 | Y_{2.91}Ce_{0.09}Al₅O₁₂ | cubic garnet-type |
| Example 8 | Y_{2.91}Ce_{0.09}Al₅O₁₂ | cubic garnet-type |
| Example 9 | Y_{2.91}Ce_{0.09}Al₅O₁₂ | cubic garnet-type |
| Example 10 | Y_{2.91}Ce_{0.09}Al₅O₁₂ | cubic garnet-type |
| Example 11 | YBa₂Cu₃O_{7-δ} | perovskite-type |
| Example 12 | YBa₂Cu₃O_{7-δ} | perovskite-type |
| Example 13 | YBa₂Cu₃O_{7-δ} | perovskite-type |
| Example 14 | YBa₂Cu₃O_{7-δ} | perovskite-type |
| Example 15 | YBa₂Cu₃O_{7-δ} | perovskite-type |
| Example 16 | YBa₂Cu₃O_{7-δ} | perovskite-type |
| Example 17 | YBa₂Cu₃O_{7-δ} | perovskite-type |
| Example 18 | YBa₂Cu₃O_{7-δ} | perovskite-type |
| Example 19 | YBa₂Cu₃O_{7-δ} | perovskite-type |
| Example 20 | YBa₂Cu₃O_{7-δ} | perovskite-type |
| Example 21 | Y₃Al_{0.6}Fe_{4.4}O₁₂ | garnet-type |
| Example 22 | Y₃Al_{0.6}Fe_{4.4}O₁₂ | garnet-type |
| Example 23 | Y₃Al_{0.6}Fe_{4.4}O₁₂ | garnet-type |
| Example 24 | Y₃Al_{0.6}Fe_{4.4}O₁₂ | garnet-type |
| Example 25 | Y₃Al_{0.6}Fe_{4.4}O₁₂ | garnet-type |
| Example 26 | Y₃Al_{0.6}Fe_{4.4}O₁₂ | garnet-type |
| Example 27 | Y₃Al_{0.6}Fe_{4.4}O₁₂ | garnet-type |
| Example 28 | Y₃Al_{0.6}Fe_{4.4}O₁₂ | garnet-type |
| Example 29 | Y₃Al_{0.6}Fe_{4.4}O₁₂ | garnet-type |
| Example 30 | Y₃Al_{0.6}Fe_{4.4}O₁₂ | garnet-type |
| Example 31 | Li_{6.3}La₃Zr_{1.3}Sb_{0.5}Ta_{0.2}O₁₂ | cubic garnet-type |
| Example 32 | Li_{6.3}La₃Zr_{1.3}Sb_{0.5}Ta_{0.2}O₁₂ | cubic garnet-type |
| Example 33 | Li_{6.3}La₃Zr_{1.3}Sb_{0.5}Ta_{0.2}O₁₂ | cubic garnet-type |

TABLE 9

| | Formulation | Crystal phase |
|---|---|---|
| Example 34 | Li_{6.3}La₃Zr_{1.3}Sb_{0.5}Ta_{0.2}O₁₂ | cubic garnet-type |
| Example 35 | Li_{6.3}La₃Zr_{1.3}Sb_{0.5}Ta_{0.2}O₁₂ | cubic garnet-type |
| Example 36 | Li_{6.3}La₃Zr_{1.3}Sb_{0.5}Ta_{0.2}O₁₂ | cubic garnet-type |
| Example 37 | Li_{6.3}La₃Zr_{1.3}Sb_{0.5}Ta_{0.2}O₁₂ | cubic garnet-type |
| Example 38 | Li_{6.3}La₃Zr_{1.3}Sb_{0.5}Ta_{0.2}O₁₂ | cubic garnet-type |
| Example 39 | Li_{6.3}La₃Zr_{1.3}Sb_{0.5}Ta_{0.2}O₁₂ | cubic garnet-type |
| Example 40 | Li_{6.3}La₃Zr_{1.3}Sb_{0.5}Ta_{0.2}O₁₂ | cubic garnet-type |
| Example 41 | Li_{6.3}La₃Zr_{1.3}Sb_{0.5}Ta_{0.2}O₁₂ | cubic garnet-type |
| Example 42 | Li_{6.75}La₃Zr_{1.75}Nb_{0.25}O₁₂ | cubic garnet-type |
| Example 43 | Li_{6.75}La₃Zr_{1.75}Nb_{0.25}O₁₂ | cubic garnet-type |
| Example 44 | Li_{6.3}La₃Zr_{1.3}Sb_{0.5}Ta_{0.2}O₁₂ | cubic garnet-type |
| Example 45 | Li_{6.3}La₃Zr_{1.3}Sb_{0.5}Ta_{0.2}O₁₂ | cubic garnet-type |
| Example 46 | Li_{6.3}La₃Zr_{1.3}Sb_{0.5}Ta_{0.2}O₁₂ | cubic garnet-type |
| Example 47 | Li_{6.3}La₃Zr_{1.3}Sb_{0.5}Ta_{0.2}O₁₂ | cubic garnet-type |
| Example 48 | Li_{6.3}La₃Zr_{1.3}Sb_{0.5}Ta_{0.2}O₁₂ | cubic garnet-type |
| Example 49 | Li_{6.3}La₃Zr_{1.3}Sb_{0.5}Ta_{0.2}O₁₂ | cubic garnet-type |
| Example 50 | Li_{6.3}La₃Zr_{1.3}Sb_{0.5}Ta_{0.2}O₁₂ | cubic garnet-type |
| Example 51 | Li_{6.3}La₃Zr_{1.3}Sb_{0.5}Ta_{0.2}O₁₂ | cubic garnet-type |
| Example 52 | Li_{6.3}La₃Zr_{1.3}Sb_{0.5}Ta_{0.2}O₁₂ | cubic garnet-type |
| Example 53 | Li_{6.3}La₃Zr_{1.3}Sb_{0.5}Ta_{0.2}O₁₂ | cubic garnet-type |
| Example 54 | Li_{6.75}La₃Zr_{1.75}Nb_{0.25}O₁₂ | cubic garnet-type |
| Example 55 | Li_{6.75}La₃Zr_{1.75}Nb_{0.25}O₁₂ | cubic garnet-type |

TABLE 10

| | Formulation | Crystal phase |
|---|---|---|
| Comparative Example 1 | — | — |
| Comparative Example 2 | — | — |
| Comparative Example 3 | — | — |
| Comparative Example 4 | — | — |
| Comparative Example 5 | Y_{2.91}Ce_{0.09}Al₅O₁₂ | cubic garnet-type |
| Comparative Example 6 | YBa₂Cu₃O_{7-δ} | perovskite-type |
| Comparative Example 7 | Y₃Al_{0.6}Fe_{4.4}O₁₂ | garnet-type |
| Comparative Example 8 | Li_{6.3}La₃Zr_{1.3}Sb_{0.5}Ta_{0.2}O₁₂ | cubic garnet-type |
| Comparative Example 9 | Y_{2.91}Ce_{0.09}Al₅O₁₂ | cubic garnet-type |
| Comparative Example 10 | YBa₂Cu₃O_{7-δ} | perovskite-type |
| Comparative Example 11 | Y₃Al_{0.6}Fe_{4.4}O₁₂ | garnet-type |
| Comparative Example 12 | Li_{6.3}La₃Zr_{1.3}Sb_{0.5}Ta_{0.2}O₁₂ | cubic garnet-type |
| Comparative Example 13 | — | — |
| Comparative Example 14 | — | — |
| Comparative Example 15 | — | — |
| Comparative Example 16 | — | — |

### [10] Evaluation

The following evaluation was performed for the functional ceramic molded bodies according to the respective Examples and the respective Comparative Examples obtained as described above.

### [10-1] Evaluation of Denseness

With respect to the functional ceramic molded bodies according to the respective Examples and the respective Comparative Examples, the void ratio of the functional ceramic molded body was determined from profilometry and gravimetry. It can be said that as the void ratio is smaller, the denseness is higher. Note that in all the functional ceramic molded bodies according to the respective Examples and the respective Comparative Examples, the content of the liquid component was 0.1 mass % or less, and the content of the oxoacid compound was 10 ppm or less.

These results are collectively shown in Tables 11 to 13.

TABLE 11

| | Denseness |
|---|---|
| | Void ratio after firing [vol %] |
| Example 1 | 25 |
| Example 2 | 12 |
| Example 3 | 18 |
| Example 4 | 34 |
| Example 5 | 27 |
| Example 6 | 20 |
| Example 7 | 30 |
| Example 8 | 38 |
| Example 9 | 55 |
| Example 10 | 35/18 |
| Example 11 | 18 |
| Example 12 | 7 |
| Example 13 | 24 |
| Example 14 | 40 |
| Example 15 | 18 |
| Example 16 | 9 |
| Example 17 | 13 |
| Example 18 | 20 |
| Example 19 | 40 |
| Example 20 | 9/12 |
| Example 21 | 15 |
| Example 22 | 12 |
| Example 23 | 20 |
| Example 24 | 35 |
| Example 25 | 18 |
| Example 26 | 15 |
| Example 27 | 20 |
| Example 28 | 27 |
| Example 29 | 40 |
| Example 30 | 25/20 |

TABLE 12

| | Denseness |
|---|---|
| | Void ratio after firing [vol %] |
| Example 31 | 20 |
| Example 32 | 7 |
| Example 33 | 16 |
| Example 34 | 27 |
| Example 35 | 28 |
| Example 36 | 12 |
| Example 37 | 15 |
| Example 38 | 25 |
| Example 39 | 15 |
| Example 40 | 17 |
| Example 41 | 15 |
| Example 42 | 15 |
| Example 43 | 16 |
| Example 44 | 20 |
| Example 45 | 7 |
| Example 46 | 16 |
| Example 47 | 27 |
| Example 48 | 27 |
| Example 49 | 12 |
| Example 50 | 16 |
| Example 51 | 20 |
| Example 52 | 12 |
| Example 53 | 15 |
| Example 54 | 13 |
| Example 55 | 13 |

TABLE 13

| | Denseness |
|---|---|
| | Void ratio after firing [vol %] |
| Comparative Example 1 | Unmeasurable (unmoldable) |
| Comparative Example 2 | Unmeasurable (unmoldable) |
| Comparative Example 3 | Unmeasurable (unmoldable) |
| Comparative Example 4 | Unmeasurable (unmoldable) |
| Comparative Example 5 | 50 |
| Comparative Example 6 | 45 |
| Comparative Example 7 | 40 |
| Comparative Example 8 | 45 |
| Comparative Example 9 | Unmeasurable (unmoldable) |
| Comparative Example 10 | Unmeasurable (unmoldable) |
| Comparative Example 11 | Unmeasurable (unmoldable) |
| Comparative Example 12 | Unmeasurable (unmoldable) |
| Comparative Example 13 | Unmeasurable (unmoldable) |
| Comparative Example 14 | Unmeasurable (unmoldable) |
| Comparative Example 15 | Unmeasurable (unmoldable) |
| Comparative Example 16 | Unmeasurable (unmoldable) |

As apparent from Tables 11 and 12, excellent results were obtained in the respective Examples. On the other hand, as apparent from Table 13, satisfactory results could not be obtained in Comparative Examples.

### [10-2] Evaluation of Internal Quantum Yield

With respect to the functional ceramic molded bodies according to Examples 1 to 10 and Comparative Examples 1, 5, 9, and 13 among the functional ceramic molded bodies produced in the above [9], the following evaluation was performed.

That is, with respect to the functional ceramic molded bodies according to Examples 1 to 10 and Comparative Examples 1, 5, 9, and 13 that are phosphor ceramics, an internal quantum yield as a fluorescence property was determined by measurement using an absolute PL quantum yield measurement device (Quantaurus-QYC 11347-01, manufactured by Hamamatsu Photonics K.K.).

These results are collectively shown in Table 14.

TABLE 14

| | Internal quantum yield [%] |
|---|---|
| Example 1 | 25 |
| Example 2 | 33 |
| Example 3 | 28 |
| Example 4 | 20 |
| Example 5 | 28 |
| Example 6 | 30 |
| Example 7 | 28 |
| Example 8 | 25 |
| Example 9 | 20 |
| Example 10 | 25/20 |
| Comparative Example 1 | unmeasurable |
| Comparative Example 5 | 18 |
| Comparative Example 9 | unmeasurable |
| Comparative Example 13 | unmeasurable |

As apparent from Table 14, excellent results were obtained in Examples 1 to 10. On the other hand, satisfactory results could not be obtained in Comparative Examples.

### [10-3] Evaluation of In-Magnetic-Field Critical Current

With respect to the functional ceramic molded bodies according to Examples 11 to 20 and Comparative Examples 2, 6, 10, and 14 among the functional ceramic molded bodies produced in the above [9], the following evaluation was performed.

That is, to both main faces of each of the functional ceramic molded bodies according to Examples 11 to 20 and Comparative Examples 2, 6, 10, and 14 that are superconductor ceramics, an indium electrode was bonded, and measurement of an in-magnetic-field critical current in a magnetic field of a 3T magnet at 77.3 K that is the liquid nitrogen temperature was performed by a four-terminal method.

The results are collectively shown in Table 15.

TABLE 15

| | In-magnetic-field critical current [kA/cm²] |
|---|---|
| Example 11 | 76 |
| Example 12 | 90 |
| Example 13 | 65 |
| Example 14 | 38 |
| Example 15 | 77 |
| Example 16 | 92 |
| Example 17 | 76 |
| Example 18 | 47 |
| Example 19 | 30 |
| Example 20 | 85/80 |
| Comparative Example 2 | unmeasurable |
| Comparative Example 6 | 45 |
| Comparative Example 10 | unmeasurable |
| Comparative Example 14 | unmeasurable |

As apparent from Table 15, excellent results were obtained in Examples 11 to 20. On the other hand, satisfactory results could not be obtained in Comparative Examples.

### [10-4] Measurement and Evaluation of Magnetic Susceptibility

With respect to the functional ceramic molded bodies according to Examples 21 to 30 and Comparative Examples 3, 7, 11, and 15 among the functional ceramic molded bodies produced in the above [9], the following evaluation was performed.

That is, with respect to the functional ceramic molded bodies according to Examples 21 to 30 and Comparative Examples 3, 7, 11, and 15 that are magnetic ceramics, a saturation magnetization and a ferromagnetic resonance half width ΔH were determined using a vibrating sample magnetometer (VSM-C7, manufactured by Toei Industry Co., Ltd.).

The results are collectively shown in Table 16.

TABLE 16

| | Saturation | Ferromagnetic resonance |
|---|---|---|
| | magnetization (G) | half width ΔH (Oe) |
| Example 21 | 1050 | 58 |
| Example 22 | 1350 | 50 |
| Example 23 | 1240 | 58 |
| Example 24 | 1100 | 60 |
| Example 25 | 1100 | 60 |
| Example 26 | 1280 | 55 |
| Example 27 | 1200 | 60 |
| Example 28 | 1100 | 65 |
| Example 29 | 950 | 75 |
| Example 30 | 1100/1200 | 65 |
| Comparative Example 3 | unmeasurable | unmeasurable |
| Comparative Example 7 | 850 | 75 |
| Comparative Example 11 | unmeasurable | unmeasurable |
| Comparative Example 15 | unmeasurable | unmeasurable |

As apparent from Table 16, excellent results were obtained in Examples 21 to 30. On the other hand, satisfactory results could not be obtained in Comparative Examples.

### [10-5] Evaluation of Ion Conductivity

With respect to the solid electrolyte molded bodies that are the functional ceramic molded bodies according to Examples 31 to 55 and Comparative Examples 4, 8, 12, and 16 among the functional ceramic molded bodies produced in the above [9], the following evaluation was performed.

That is, with respect to each of the solid electrolyte molded bodies, a lithium metal foil having a diameter of 8 mm (manufactured by Honjo Chemical Corporation) was bonded to both faces, whereby activated electrodes were formed. Then, an AC impedance was measured using an AC impedance analyzer Solartron 1260 (manufactured by Solartron Analytical, Inc.), and the lithium ion conductivity was determined. The measurement was performed at an AC amplitude of 10 mV in a frequency range from 10⁷ Hz to 10⁻¹ Hz. The lithium ion conductivity obtained by the measurement shows the total lithium ion conductivity including the bulk lithium ion conductivity and the grain boundary lithium ion conductivity in each solid electrolyte molded body. It can be said that as this value is larger, the ion conductivity is higher.

These results are collectively shown in Table 17.

TABLE 17

| | Ion conductivity (mS/cm) |
|---|---|
| Example 31 | 0.2 |
| Example 32 | 0.3 |
| Example 33 | 0.2 |
| Example 34 | 0.1 |
| Example 35 | 0.17 |
| Example 36 | 0.2 |
| Example 37 | 0.2 |
| Example 38 | 0.15 |
| Example 39 | 0.2 |
| Example 40 | 0.1 |
| Example 41 | 0.1 |
| Example 42 | 0.08 |
| Example 43 | 0.08 |
| Example 44 | 0.4 |
| Example 45 | 1.1 |
| Example 46 | 0.5 |
| Example 47 | 0.15 |
| Example 48 | 0.2 |
| Example 49 | 0.7 |
| Example 50 | 0.4 |
| Example 51 | 0.2 |
| Example 52 | 0.7 |
| Example 53 | 0.6 |
| Example 54 | 1 |
| Example 55 | 1 |
| Comparative Example 4 | unmeasurable |
| Comparative Example 8 | 0.05 |
| Comparative Example 12 | unmeasurable |
| Comparative Example 16 | unmeasurable |

As apparent from Table 17, excellent results were obtained in Examples 31 to 55. On the other hand, satisfactory results could not be obtained in Comparative Examples.

As described above, according to the present disclosure, excellent results were obtained in all the cases regardless of the type of the functional ceramic.

Further, when the production of functional ceramic molded bodies was attempted in the same manner as described above except that the condition of the firing temperature was changed within a range of 700° C. or higher and 1000° C. or lower using the solid compositions of the respective Examples and the respective Comparative Examples, in the respective Examples, the functional ceramic molded bodies could be favorably produced, and excellent results were obtained in the same manner as described above. On the other hand, in Comparative Examples, satisfactory results could not be obtained.

What is claimed is:

1. A method for producing a solid composition, comprising:
producing an oxide to be converted into a first functional ceramic by reacting with an oxoacid compound; and
mixing the oxide, the oxoacid compound, and a second functional ceramic that is different from the first functional ceramic.

2. The method for producing a solid composition according to claim 1, wherein the producing the oxide is performed by subjecting a mixture containing multiple types of metal compounds as raw material substances to a heat treatment.

3. The method for producing a solid composition according to claim 1, wherein 0.001≤XO/XP≤4.00 in which XP is a content [mass %] of the oxide in the solid composition and XO is a content [mass %] of the oxoacid compound in the solid composition.

4. The method for producing a solid composition according to claim 1, wherein the oxoacid compound contains at least one of a nitrate ion and a sulfate ion as an oxoanion.

5. The method for producing a solid composition according to claim 1, wherein 0.05≤XP/X2≤1.20 in which XP is a content [mass %] of the oxide in the solid composition and X2 is a content [mass %] of the second functional ceramic in the solid composition.

6. The method for producing a solid composition according to claim 1, wherein the second functional ceramic has an average particle diameter of 1.0 μm or more and 20 μm or less.

7. The method for producing a solid composition according to claim 1, wherein
a crystal phase constituting the oxide is a pyrochlore-type crystal, and
a crystal phase constituting the first functional ceramic is a cubic garnet-type crystal.

8. The method for producing a solid composition according to claim 1, wherein
a crystal phase constituting the oxide is a perovskite-type crystal, and
a crystal phase constituting the first functional ceramic is a cubic garnet-type crystal.

9. The method for producing a solid composition according to claim 1, wherein
a crystal phase constituting the oxide is a cubic crystal, and
a crystal phase constituting the first functional ceramic is a perovskite-type crystal.

10. The method for producing a solid composition according to claim 1, wherein
a crystal phase constituting the oxide is a YFeO₃-type crystal, and
a crystal phase constituting the first functional ceramic is a garnet-type crystal.

11. The method for producing a solid composition according to claim 1, wherein the oxide has a crystal grain diameter of 10 nm or more and 200 nm or less.

12. A method for producing a functional ceramic molded body, comprising:
a molding step of obtaining a molded body using a solid composition obtained using the method for producing a solid composition according to claim 1; and
a heat treatment step of subjecting the molded body to a heat treatment so as to react the oxide and the oxoacid compound in the solid composition to cause conversion to the first functional ceramic, thereby forming a functional ceramic molded body containing the first functional ceramic and the second functional ceramic.

13. The method for producing a functional ceramic molded body according to claim 12, wherein a heating temperature of the molded body in the heat treatment step is 700° C. or higher and 1000° C. or lower.
